(19) United States
(12) Patent Application Publication
(10) Pub. No.: US 2014/0185992 A1
(43) Pub. Date: Jul. 3, 2014

(54) FIBER OPTIC MODULE HOUSING AND FIBER OPTIC MODULE

(71) Applicant: CORNING CABLE SYSTEMS (SHANGHAI) CO. LTD, Shanghai (CN)

(72) Inventors: Guy Joachin Castonguay, Peoria, AZ (US); Bin Dai, Shanghai (CN); Yu Pan, Shanghai (CN); Howard Clark Schwartz, Dallas, TX (US)

(73) Assignee: CORNING CABLE SYSTEMS (SHANGHAI) CO. LTD, Shanghai (CN)

(21) Appl. No.: 14/202,446

(22) Filed: Mar. 10, 2014

Related U.S. Application Data
(63) Continuation of application No. PCT/CN11/01570, filed on Sep. 16, 2011.

(51) Int. Cl. G02B 6/36; G02B 6/46

(52) U.S. Cl. CPC G02B 6/36; G02B 6/46
USPC 385/88; 29/428

(57) ABSTRACT

The present disclosure provides fiber optic module housings and fiber optic modules that support fiber optic connections. In the present disclosure, a particular fiber optic module housing or fiber optic module includes a front side having a plurality rows of apertures for supporting fiber optic adapters, a rear side, a top side, a bottom side, and a base side. In one embodiment of the present disclosure, the fiber optic module housing or fiber optic module includes a plurality of ribs with each of the plurality of ribs being configured between two adjacent rows of the apertures on the front side to enhance the strength of the fiber optic module housing or fiber optic module, especially when it is made from plastic materials.

### RELATED APPLICATIONS

This application claims the benefit of priority under 35 U.S.C. §365 of International Patent Application No. PCT/CN11/001,570 filed on Sep. 16, 2011, the content of which is relied upon and incorporated herein by reference in its entirety.

### BACKGROUND

1. Field of the Disclosure

The present disclosure relates generally to fiber optic module housings and fiber optic modules that support fiber optic connections.

2. Technical Background

Fiber optic communication networks are being widely used to transmit signals for voice, video, data and the like because they can provide benefits of extremely wide bandwidth and low noise operation. These fiber optic networks include many connection points at which it is necessary to link optical fibers in order to provide “live fiber” from one connection point to another connection point.

In fiber optic communication networks, data centers (or central offices) are mission critical components responsible for managing, storing and protecting the network's core operational date and for running applications essential to the networks. Therefore, a data center (or a central office) usually concentrates a large number of connection points and fiber optic cables that interconnect these connection points and frequently uses fiber optic routing equipment to support the interconnections among the connection points.

To orderly and efficiently route and connect fiber optic cables among the connection points in fiber optic communication networks, data centers frequently use rack cabinets as centralized connection equipment. Usually, a rack cabinet includes a plurality of rows of racks with each of the racks having one or more columns of uniformed rack slots. Each of the rack slots can accommodate a fiber optic module, which contains a plurality of connection components within its housing (i.e. fiber optic module housing), including fiber optic adapters, fiber optic connectors and wiring harnesses.

Because space in data centers is at a premium, fiber optic module housings (or modules) are usually designed to have a relatively compact size to be fit in the uniformed and/or standardized rack slots, which causes difficulty for a craft to access the connection components inside the fiber optic module housings (or modules) during installation, re-installation and maintenance operations.

Traditionally, fiber optic module housings are constructed of metal. Even though the traditional metal fiber optic module housings (or modules) meet the strength requirement with relatively thin surrounding walls, they are relatively expensive due to material costs. With increasing use of data centers in different organizations or institutions, some applications demand more economical solutions.

Therefore, there is a need to provide a fiber optic module housing (or a fiber optic module) that allows for improved accessibility to the components therein, including but not limited to adapters and connectors.

To provide economical solutions, there is a further need to provide a fiber optic module housing (or a fiber optic module) that is made from plastic materials, but has structures to enhance the strength of the fiber optic module without increasing its size and with improved accessibility to the components therein, including but not limited to connectors and adapters.

### SUMMARY

To overcome the shortcomings in the existing fiber optic module housings (or fiber optic modules), the present disclosure provides an improved fiber optic module housing (or fiber optic module).

In a first aspect, the present disclosure provides a fiber optic module housing, which comprises:

a front side having a plurality of rows of apertures for supporting a first set of fiber optic adapters;

a rear side having a plurality of apertures for supporting a second set of fiber optic adapters;

a top side having a window that is located near to the joint location between the front side and the top side;

a bottom side having a window that is located near to the joint location between the front side and the bottom side; and

a base side;

wherein the front side, rear side, top side, bottom side and base side form a main body having an internal chamber.

The fiber optic module housing in the first aspect further comprises: a plurality of ribs with each of the plurality of ribs being configured between two adjacent rows of the apertures on the inner surface of the front side.

Corresponding to the fiber optic module housing in the first aspect, the present disclosure provides a method for assembling a fiber optic module, which comprises the steps of:

proving a cover and two window covers;

providing a main body that comprises:

a front side having a plurality of rows of apertures for supporting a first set of fiber optic adapters;

a rear side having a plurality of apertures for supporting a second set of fiber optic adapters;

a top side having a window that is located near to the joint location between the front side and the top side;

a bottom side having a window that is located near to the joint location between the front side and the bottom side; and

a base side;

wherein the front side, rear side, top side, bottom side and base side form a main body having an internal chamber;

installing the first set of fiber optic adapters onto the plurality of rows of apertures on the front side and the second set of fiber optic adapters onto the rear side;

installing a first set of fiber optic connectors onto the first set of fiber optic adapters and a second set of fiber optic connectors onto the second set of fiber optic adapters, wherein a plurality of fiber optic cables are connected between the first set of fiber optic connectors and the second set of fiber optic connectors to form a wiring harness;

installing the two window covers on the two windows on the top side and the bottom side, respectively; and

installing the cover on the main body to form the fiber optic module.

Corresponding to the method for assembling the fiber optic module in the first aspect, the main body further comprises:

a plurality of ribs with each of the plurality of ribs being configured between two adjacent rows of the apertures on the inner surface of the front side.

In a second aspect, the present disclosure provides a fiber optic module housing, which comprises:

a front side having a plurality of rows of apertures for supporting a first set of fiber optic adapters;

a rear side having a plurality of apertures for supporting a second set of fiber optic adapters;

a top side, a bottom side and a base side; and

wherein the rear side, top side, bottom side and base side form a body base;

wherein the front side includes a plurality of ribs with each of the ribs being configured between two adjacent rows of the apertures on the inner surface of the front side.

The fiber optic module housing in the second aspect, wherein:

the front side is separately made and installed onto the body base to form a main body having an internal chamber.

Corresponding to the fiber optic module housing in the second aspect, the present disclosure provides a method for assembling a fiber optic module, which comprises the steps of:

providing a cover and a front side having a plurality of rows of apertures on its inner surface for supporting a first set of fiber optic adapters;

providing a body base that includes:

a rear side having a plurality of apertures for supporting a second set of fiber optic adapters; and

a top side, a bottom side and a base side;

installing the front side onto the body base to form a main body having an internal chamber;

installing the first set fiber optic adapters on the plurality of rows of apertures on the front side and the second set of fiber optic adapters on the rear side;

installing a first set of fiber optic connectors on the first set of fiber optic adapters and a second set of fiber optic connectors on the second set of fiber optics adapters, wherein a plurality of fiber optic cables are connected between the first set of fiber optic connectors and the second set of fiber optic connectors to form a wiring harness; and

installing the cover onto the main body to form the fiber optic module.

Corresponding to the method for assembling the fiber optic module in the second aspect, the main body further comprises:

a plurality of ribs with each of the plurality of rows of ribs being configured between two adjacent rows of the apertures on the inner surface of the front side.

In a third aspect, the present disclosure provides a fiber optic module housing, which comprises:

a front side having a plurality of rows of slots for supporting a first set of fiber optic adapters with each of the slots having a top opening;

a rear side having a plurality of apertures for supporting a second set of fiber optic adapters; and

a base side, a top side and a bottom side;

wherein the front side, rear side, base side, top side, and bottom side form a main body and are made as one unit (or one piece).

The fiber optic module housing in the third aspect, wherein:

the front side includes a plurality of wall sections with each of the wall sections being formed between two adjacent rows of slots; and

at least one rib is configured on each of the wall sections.

Corresponding to the fiber optic module housing in the third aspect, the present disclosure provides a method for assembling a fiber optic module, which comprises the steps of:

providing a cover;

providing a main body that includes:

a front side having a plurality of rows of slots for supporting a first set of fiber optic adapters with each of the slots having a top opening;

a rear side having a plurality of apertures for supporting a second set of fiber optic adapters; and

a base side, a top side and a bottom side;

installing the first set fiber optic adapters onto the plurality of rows of apertures on the front side and the second set of second set of fiber optic adapters onto the rear side;

installing a first set of fiber optic connectors onto the first set of fiber optic adapters and a second set of fiber optic connectors onto the second set of fiber optic adapters, wherein a plurality of fiber optic cables are connected between the first and second sets of fiber optic connectors to form a wiring harness; and

installing the cover on the main body to form the fiber optic module.

Corresponding to the method for assembling the fiber optic module in the third aspect, the main body further comprises:

a plurality of wall sections with each of the wall sections being formed between two adjacent rows of slots on the inner surface of the front side; and

at lest one rib is configured on each of the wall sections.

In a fourth aspect, the present disclosure provides a fiber optic module housing, which comprises:

a front side having a plurality of rows of apertures for supporting a first set of fiber optic adapters;

a rear side having a plurality of apertures for supporting a second set of fiber optic adapters;

a top side, a bottom side and a base side;

wherein the rear side, top side, bottom side and base side form a body base having an internal chamber.

wherein the front side is separately made and later installed onto the body base to form a main body having an internal chamber.

The fiber optic module housing in the fourth aspect further comprises:

a plurality of attachment means for securing the cover onto the main body, wherein the plurality of attachment means are disposed on and round the open edges of the cover, front side and the body base.

Corresponding to the fiber optic module housing in the fourth aspect, the present disclosure provides a method for assembling a fiber optic module, which comprises the steps of:

providing a cover;

providing a front side having a plurality of rows of apertures for supporting a first set of fiber optic adapters;

providing a body base that includes:

a rear side having a plurality of apertures for supporting a second set of fiber optic adapters; and

a base side, a top side and a bottom side;

wherein the rear side, top side, bottom side and base side form a body base having an internal chamber;

installing the first set of fiber optic adapters on the plurality of rows of apertures on the front side and the second set of fiber optic adapters on the rear side;

installing a first set of fiber optic connectors onto the first set of fiber optic adapters and a second set of fiber optic connectors onto the second set of fiber optics adapters, wherein a plurality of fiber optic cables are connected to the first and second sets of fiber optic connectors to form a wiring harness;

installing the front side onto the base body to form a main body;

installing the cover on the main body to form the fiber optic module.

Corresponding to the method for assembling the fiber optic module in the fourth aspect, the fiber optic module further comprises:

a plurality of attachment means for securing the cover onto the main body, wherein the plurality of attachment means are disposed on and round the open edges of the cover, front side and the body base.

By providing the structures in the above mentioned fiber optic module housing and the steps in the above mentioned methods for assembling a fiber optic module, the present disclosure overcomes the above mentioned shortcomings in the existing fiber optic module housings and fiber optic modules.

### BRIEF DESCRIPTION OF THE DRAWINGS

FIGS. 1A-1C depict exemplary fiber optic module housings according to the first embodiment of the present disclosure;

FIGS. 2A-2B depict the two window covers 33 that are used to seal the two windows 25 shown in FIGS. 1A-1C;

FIGS. 3A-3B show two different structures for the two windows 25 shown in FIGS. 1A-1C;

FIGS. 4A-4B depict the top and bottom perspective views of the fiber optic module housing 10 as described in connection with FIG. 1A;

FIGS. 5A-5C depict structure details for the two window covers 41 in FIGS. 4A-4B;

FIGS. 6A-6D depict the mechanism to enhance the strength of the front side 12 (12′ or 12″) on the main body 11 (11′ or 11″) on the fiber optic module housings shown in FIGS. 1A-1C;

FIGS. 7A-7E depict the structures of the cover 18 that can be assembled onto the main body 11 (11′ or 11″) in FIGS. 1A-1C in greater details;

FIGS. 8A-8B illustrate a process of installing the cover 18 in FIGS. 7A-7E onto the main body 11 (11′ or 11″) in FIGS. 1A-1C;

FIGS. 9A-9D depict the structures of the two flanges 27 shown in FIGS. 1A-1C in greater details;

FIGS. 10A-10E depict the perspective views of an exemplary fiber optic module housing according to the second embodiment of the present disclosure;

FIGS. 11A-11B depict the structures of the cover 88, which is mentioned in connection with the description in FIG. 10A, in greater detail;

FIG. 12A-12B shows the rear perspective views of an exemplary main body 121 according to the third embodiment of the present disclosure;

FIGS. 13A-13B depict the structures of the cover 128, which is mentioned in connection with the description for FIG. 12A, in greater detail; and

FIGS. 14A-14C respectively depict the three main bodies 11, 11′ and 11″, in which all components (including the adapters, connectors and wiring harness) are installed in the internal chamber of the main bodies of the fiber optic modules in the present disclosure.

### DETAILED DESCRIPTION OF THE EMBODIMENTS

Reference is now made to the embodiments, examples of which are illustrated in the accompanying drawings. In the detailed description of the embodiments, directional or sequential terminology, such as “top,” “bottom,” “front,” “rear,” “back,” “horizontal,” “vertical,” “row,” “column,” “first,” “second,” etc., is used with reference to the orientation or sequence of the Figure(s) being described. Because components of embodiments in the present disclosure can be positioned in a number of different orientations, the directional or sequential terminology is used for purposes of illustration and is in no way limiting. Whenever possible, the same or similar reference numbers and symbols are used throughout the drawings to refer to the same or similar parts.

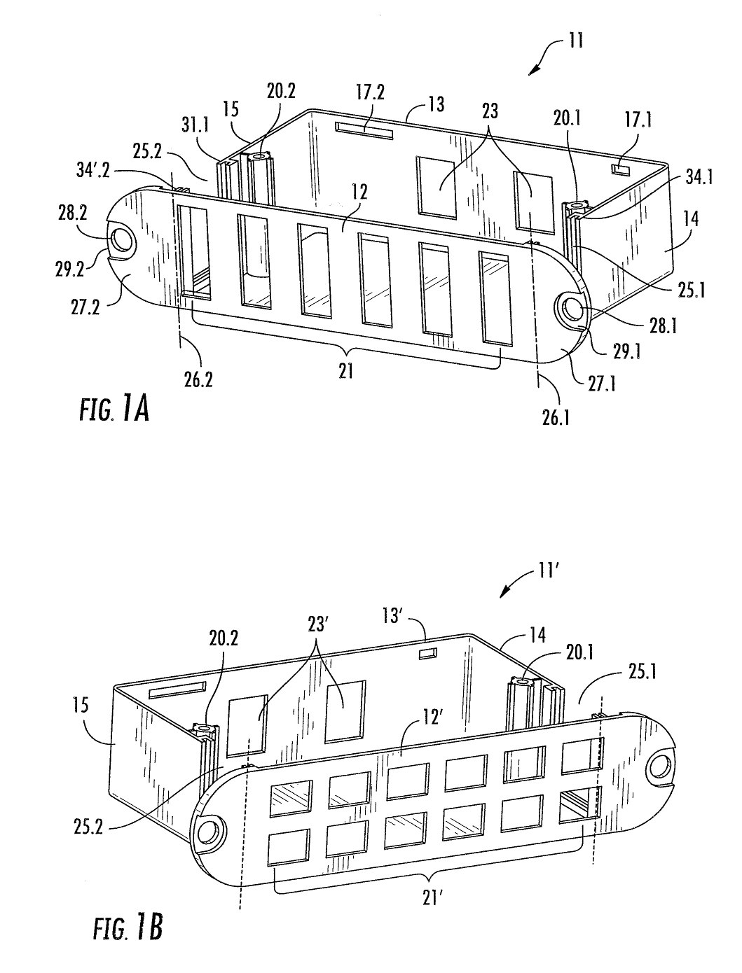

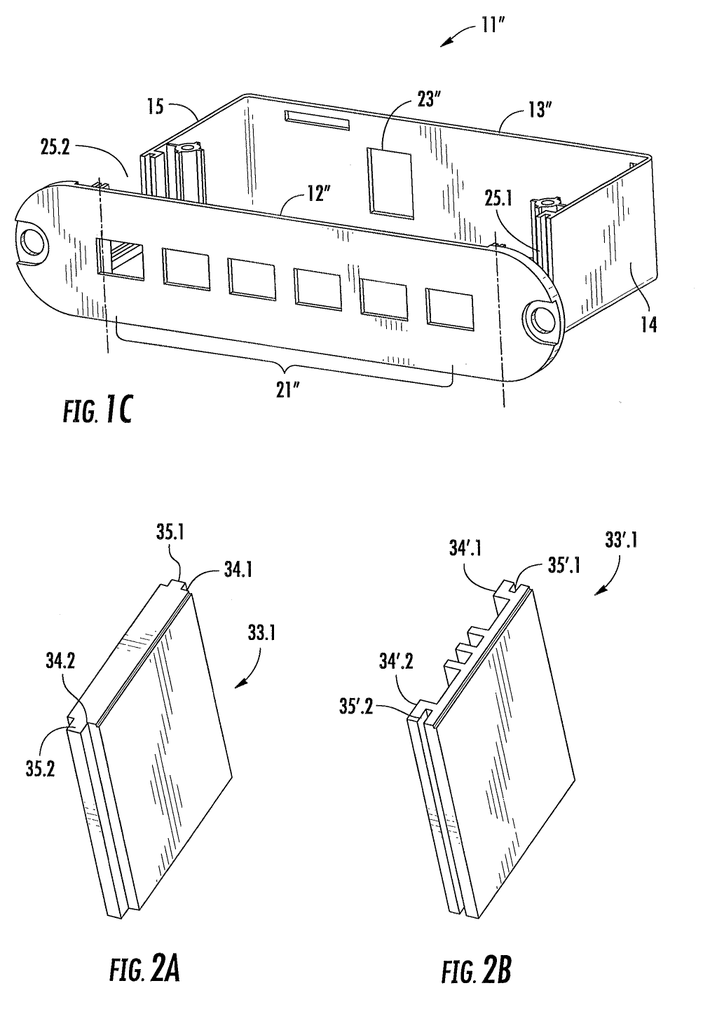

FIGS. 1A-1C depict exemplary fiber optic module housings (or modules) 10 according to the first embodiment of the present disclosure, in which two windows are configured on the main body of the fiber optic module housings (or fiber optic modules).

FIG. 1A depicts the front perspective view of an exemplary main body 11 of the fiber optic module housing 10 (not shown in FIG. 1A) according to the first embodiment of the present disclosure. The fiber optic module housing 10 includes a front side 12, a rear side 13, a top side 14, a bottom side 15, a base side 16 (not shown in FIG. 1A) and a cover 18 (not shown in FIG. 1A). The front side 12, rear side 13, top side 14, bottom side 15 and base side 16 are made as one unit to form the main body 11 having an internal chamber 19 (not shown in FIG. 1A). The front side 12, rear side 13, top side 14, bottom side 15, base side 16, two window covers 33 (shown in FIGS. 2A-2B) and cover 18 can be assembled together as the fiber optic module housing 10. The main body 11 comprises two windows 25 (25.₁, 25.₂) to facilitate accessing to the components in the internal chamber 19. To provide installation support for the cover 18, two snap slots 17 (17.₁, 17.₂) are configured on the rear side 13 and two bosses 20 (20.₁, 20.₂) are configured on the base side 16.

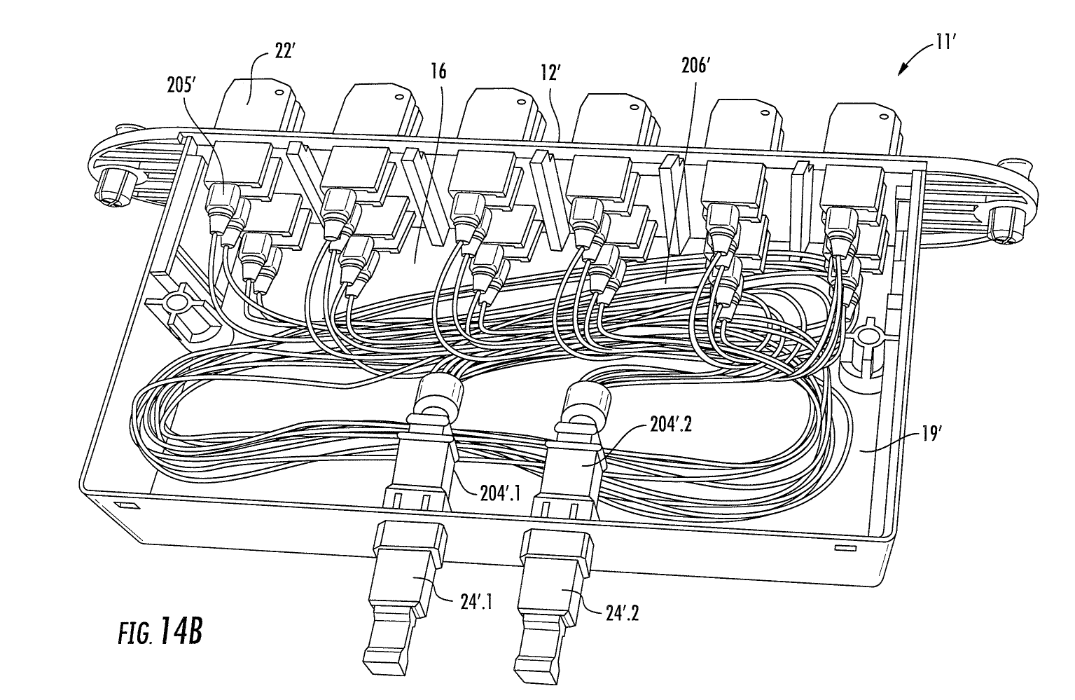

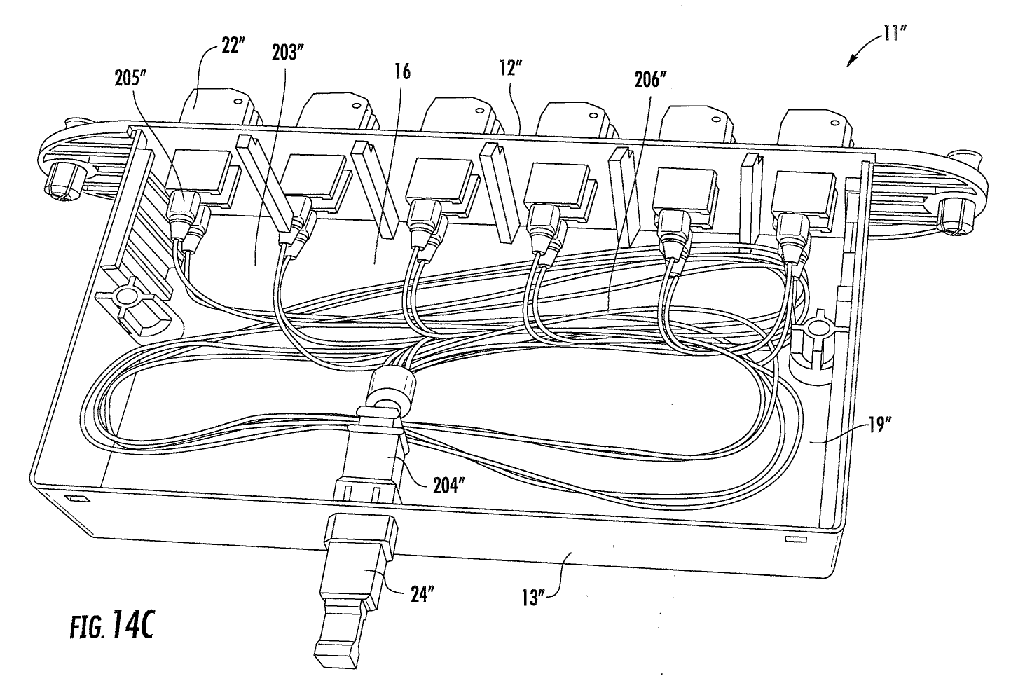

In FIG. 1A, the front side 12 includes six apertures 21 that are arranged in six rows and one column for supporting six quadruplet LC fiber optic adapters (or 12 duplex LC adapters) 22 with each of which being able to receive four (or 2) LC fiber optic connecters 205 (shown in FIG. 14A). The rear side 13 includes two apertures 23 for supporting two MTP adapters 24 with each of which being able to receiving one MTP fiber optic connector 204 (shown in FIG. 14A). In the configuration shown in FIG. 1A, each of the two MTP adapters 24 receives two inputting optic cable with 12 fiber cores that are included in the two MTP connectors. The twelve connections split from the one inputting optic cable is then attached to the twelve LC fiber optic connectors 205 (shown in FIG. 14A), which are in turn inserted onto three of the six quadruplet (or six duplex) LC fiber optic adapters 22.

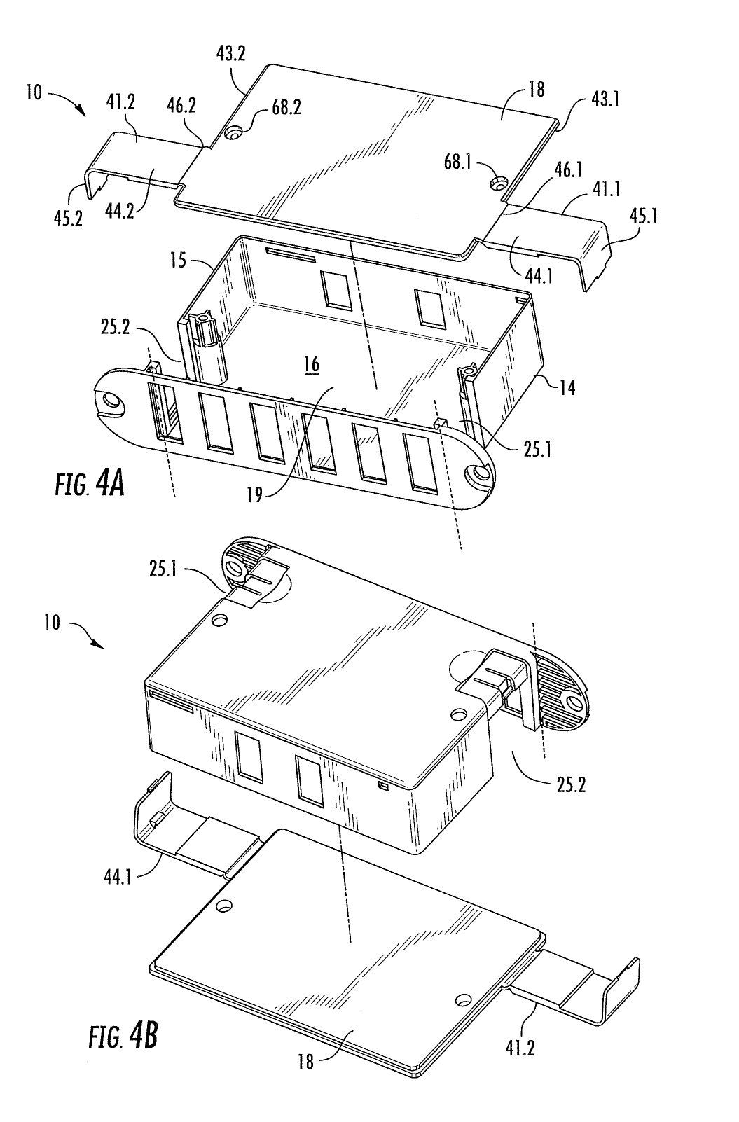

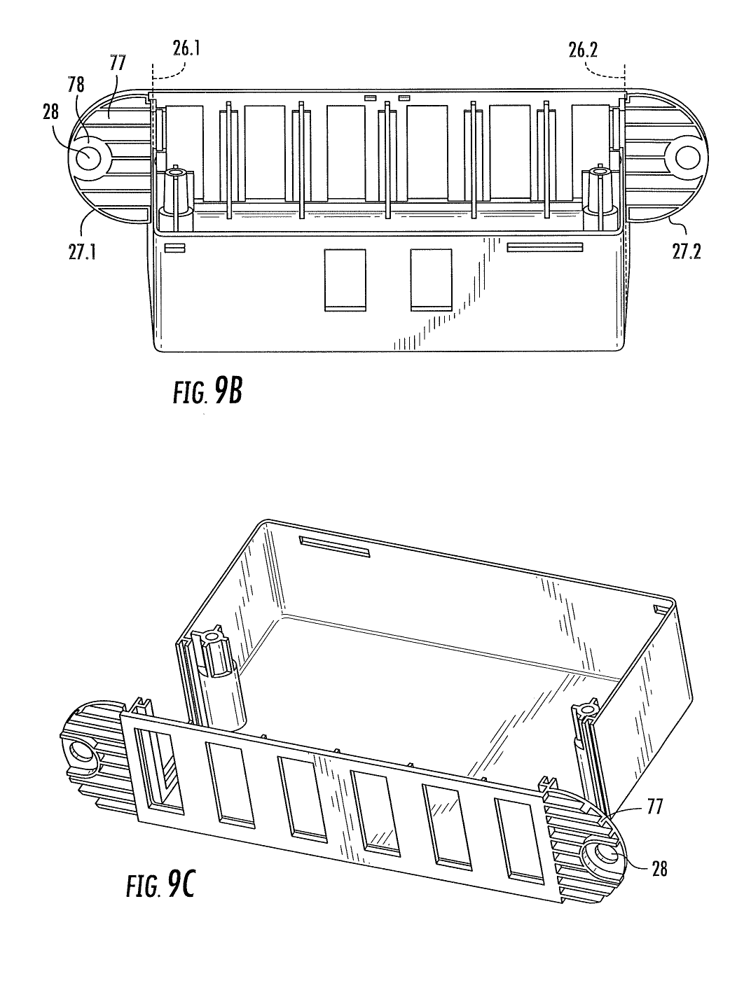

Due to the illustrative limitation in a perspective view, the FIG. 1A does not show some of the components in the fiber optic module housing 10, including the base side 16, cover 18 and chamber 19. These components are to be shown in FIG. 4A or 8A.

FIG. 1B depicts the front perspective view of another exemplary main body 11′ of the fiber optic module housing 10′ according to the first embodiment of the present disclosure. In FIG. 1B, the structures of all components on the fiber optic module housing 10′ are identical to those in FIG. 1A, except that the fiber optic module housing 10′ has different number and shape of apertures on its front side 12′.

Specifically, as shown in FIG. 1B, the front side 12′ includes twelve apertures 21′ that are arranged in six rows and two columns for supporting twelve duplex LC fiber optic adapters 22′ with each of the LC fiber optic adapters being able to receiving two LC fiber optic connectors 205′ (shown in FIG. 14B). The rear side 13′ includes two apertures 23′ for supporting two MTP adapters 24′ with each of which is able to receiving one MTP fiber optic connector 204′ (shown in FIG. 14B). In the configuration of FIG. 1B, each of the two MTP adapters 24′ receives an inputting optic fiber ribbon cable that is usually split into twelve connections. The twelve connections are then attached to twelve LC fiber optic connectors 205′ (shown in FIG. 14B), which are in turn inserted onto six of the twelve duplex LC fiber optic adapters 22′.

FIG. 1C depicts the front perspective view of another exemplary main body 11″ of the fiber optic module housing 10″ according to the third embodiment of the present disclosure. In FIG. 1C, all components on the fiber optic module housing 10″ are identical to those in FIG. 1A, except that the fiber optic module housing 10″ has different number and shape of apertures on its front side 12″ and different number of apertures on its rear side 13″.

Specifically, in FIG. 1C, the front side 12″ includes six apertures 21″ that are arranged in six rows and one column for supporting six duplex LC fiber optic adapters 22″ (shown in FIG. 14C) with each being able to receiving two LC fiber optic connectors 205″. The rear side 13″ includes an aperture 23″ for supporting one MTP adapter 24″ which can receive one MTP fiber optic connector 204″ (shown in FIG. 14C). In the configuration of FIG. 1C, the MTP adapter 24″ receives an inputting optic fiber ribbon cable that is usually split into twelve connections. The twelve connections are then attached to twelve LC fiber optic connectors 205″ (shown in FIG. 14C), which are in turn inserted onto the six duplex LC fiber optic adapters 22″.

As shown in FIGS. 1A-1C, to facilitate accessing to the fiber optic adapters and the corresponding fiber optic connectors at the top-most row and bottom-most row, the top side 14 includes a window 25.₁ near to the joint location between the front side 12 (or 12′, 12″) and the top side 14, and the bottom side 15 includes a window 25.₂ near to the joint location between the front side 12 (or 12′, 12″) and the bottom side 15. The two windows 25 (25.₁, 25.₂) are so configured so that a craft can easily put his/her fingers into the two windows to insert the connectors into or pull the connectors out of the two adapters at the top-most row and bottom-most row.

The inventors realize the two adapters (together with the connectors inserted thereon) at the top-most row and bottom-most row are most difficult to access because there are no sufficient spaces between the two adapters and the top side 14 and bottom side 15 while all other adapters can be relatively easily accessed because of the relatively larger spaces behind the front side 12 in the internal chamber. By respectively arranging the two windows on the top side 14 and bottom side 15 at the locations that are adjacent to the adapters located on the top-most row and bottom-most row, the present disclosure minimizes the size of the two windows 25 on the top side 14 and bottom side 15 while allows easy access to all adapters and connectors inside the fiber optic module housing.

As further shown in FIGS. 1A-1C, the front side 12 (or 12′, 12″) includes a top section 26.₁ and bottom section 26.₂ at the locations that are aligned with the top side 14 and bottom side 15, respectively. To secure the fiber optic module housings (or fiber optic modules) in a rack slot on a rack cabinet, two flanges 27 (27.₁, 27.₂) are configured on the top section 26.₁ and bottom section 26.₂, respectively, with each of the two holes 28.₁, 28.₂ having an undercut 29.₁, or 29.₂.

It should be appreciated that the front side 12, 12′ or 12′″ and rear side 13, 13′ or 13″ in FIGS. 1A-1C show three particular arrangements of apertures for supporting fiber optic adapters, but other aperture arrangements are possible.

FIGS. 2A-2B depict two different structures for two window covers 33 (33.₁, 33.₂) and two window covers 33′ (33′.₁, 33′.₂), which are used to seal the two windows 25 (25.₁, 25.₂) on the top side 14 and bottom side 15 shown in FIGS. 1A-1C. As shown in FIG. 2A, the window cover 33.₁ has two side edges 34 (34.₁, 34.₂) with each of the side edges having two protrusions 35 (35.₁, 35.₂). As shown in FIG. 2B, the window cover 33′ 33′.₁ has two side edges 34′ (34′.₁, 34′.₂) with each of the side edges having two grooves 35′ (35′.₁, 35′.₂). Because the two window covers 33 (33.₁, 33.₂) or two window covers 33′ (33′.₁, 33′.₂) are symmetrically structured, the structure details for the window cover 33.₂ or window 33′.₂ are sufficiently reflected in FIGS. 2A-2B.

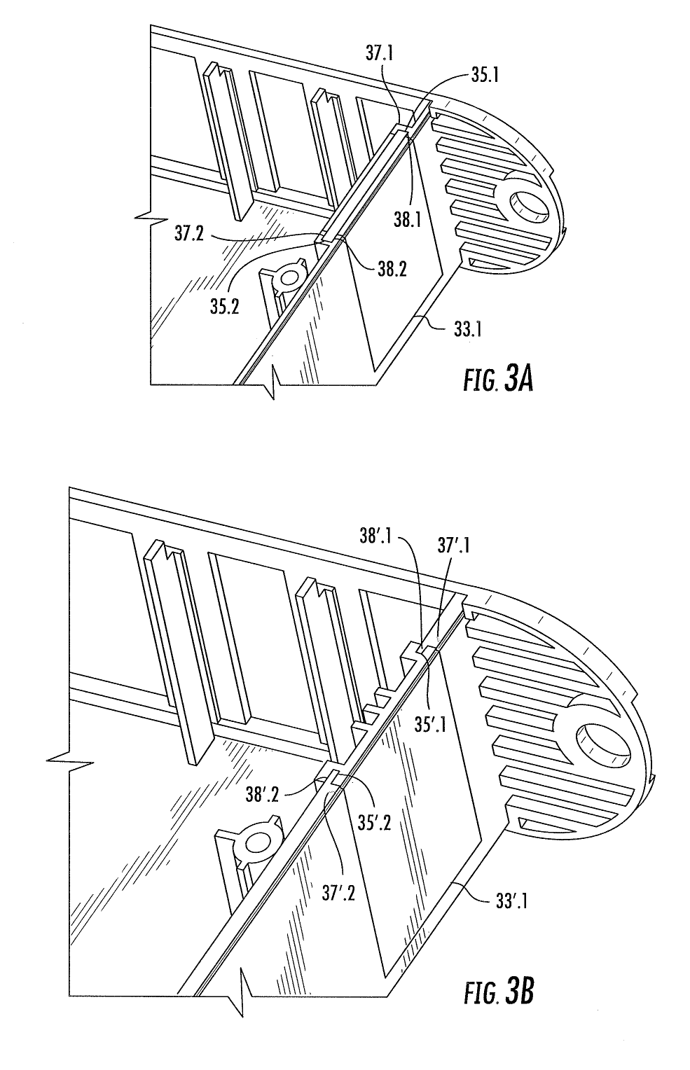

FIGS. 3A-3B show two different structures for the two windows on the top side 14 and bottom side 15, respectively. In FIG. 3A, the two windows 25 (25.₁, 25.₂), which are structurally symmetrical, have two side frames 37 (37.₁, 37.₂) with each having two grooves 38 (38.₁, 38.₂). In installation, the two protrusions 35 (35.₁, 35.₂) on the window cover 33.₁, are inserted into the two grooves 38.₁, 38.₂ on the window 25.₁. Because the window 25.₂ is structurally symmetrical to the window 25.₁, the structural details to install the window cover 33.₂ onto the window 25.₂ are sufficiently reflected in the above descriptions to install the window cover 33.₁ onto the window 25.₁.

In FIG. 3B, the two windows 25.₁ and 25.₂, which are structurally symmetrical, have two side frames 37′.₁, 37′.₂ with each having two protrusions 38′.₁, 38′.₂. In installation, the two grooves 35′.₁, 35′.₂ on the window cover 33′.₁ are inserted around the two protrusions 38′.₁, 38′.₂ on the window 25.₁. Because the window 25.₂ is structurally symmetrical to window 25.₁, the structural details to install the window cover 33′.₂ onto the window 25.₂ are sufficiently reflected in the above descriptions in connection with installing the window cover 33′.₁ onto the window 25.₁.

FIGS. 4A-4B depict the top and bottom perspective views of the fiber optic module housing 10, in which the two window covers are to be attached onto two windows on the main body 11 as shown in FIG. 1A. As shown in FIG. 4A, the cover 18 has a top edge 43.₁ and a bottom edge 43.₂. The two L-shaped window covers 41 (41.₁, 41.₂), with each having a cover body 44.₁ (or 44.₂) and a cover arm 45.₁ (or 45.₂), are linked to the top and bottom edges 43.₁, 43.₂ using two hinges 46.₁, 46.₂, respectively. The two hinges 46.₁, 46.₂ can be formed from the injection molding or extrusion process in creating the cover 18, so that the two window covers 41 (41.₁, 41.₂) can rotate around the top and bottom edges 43.₁, 43.₂, respectively. As shown in FIG. 4B, when the two window covers 41 (41.₁, 42.₂) rotate around the top and bottom edges 43.₁, 43.₂, the two cover bodies 44 (44.₁, or 44.₂) seal the two windows 25.₁, 25.₂ until the two cover arms 45 (45.₁ or 45.₂) are wrapped around the top side 14 and bottom side 15.

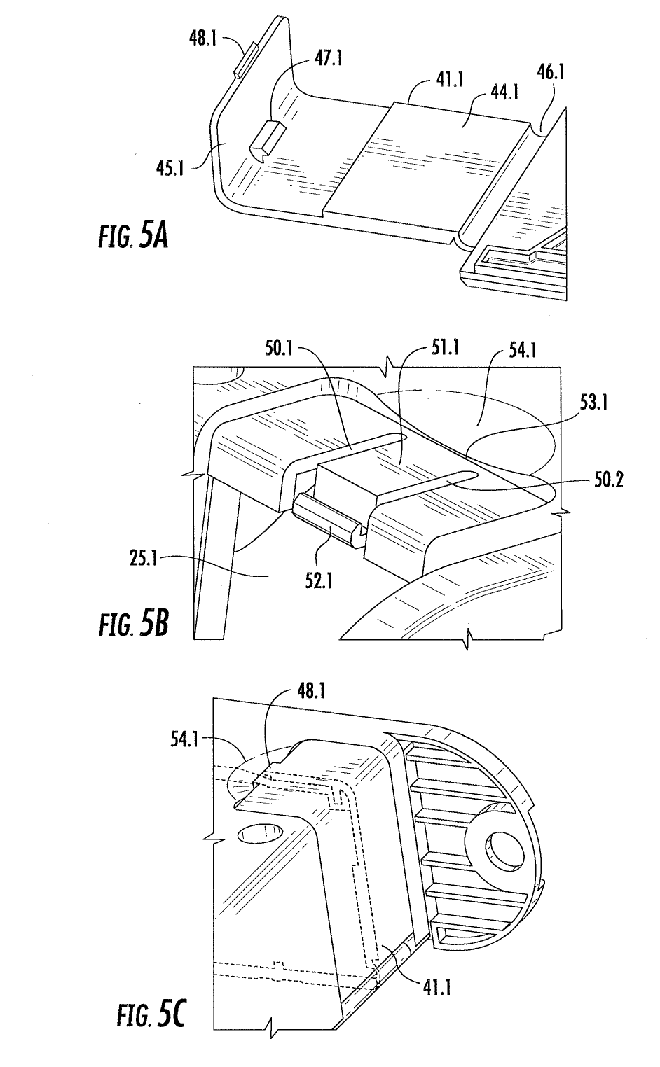

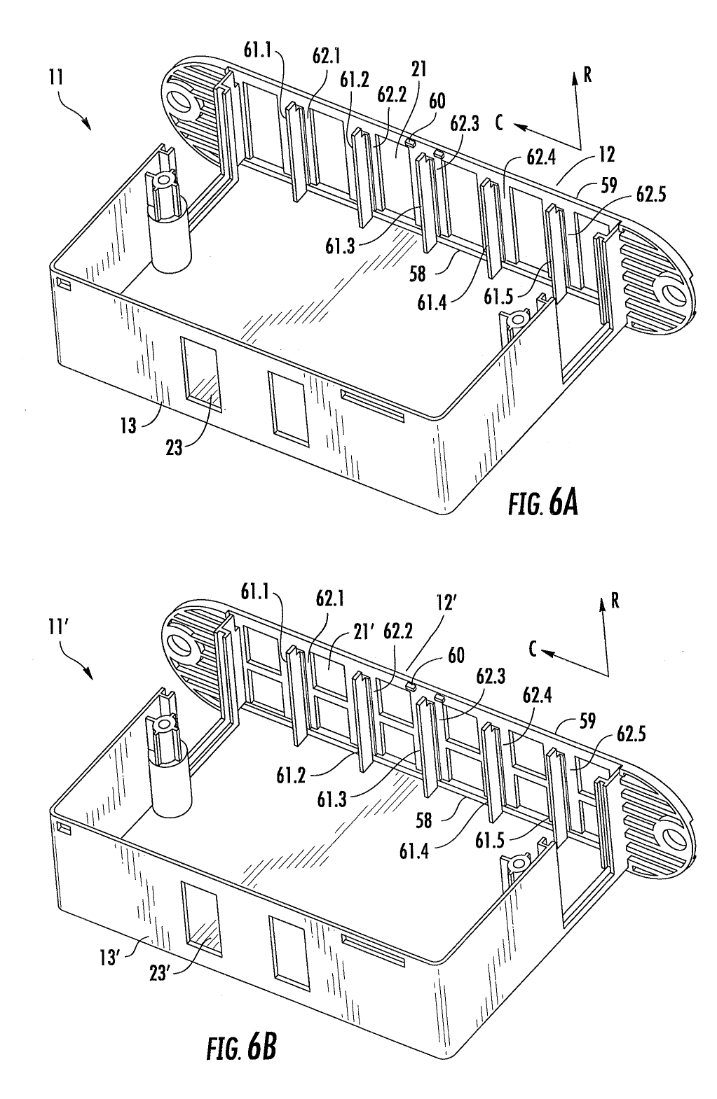

FIGS. 5A-5C depict structure details for the two window covers 41 (41.₁, 41.₂) shown in FIGS. 4A-4B to wrap around the top side 14 and bottom side 15 at the places where the two windows 25 (25.₁, 25.₂) are located, respectively. To attach the two window covers 41 (41.₁, 41.₂) onto the two windows 25 (25.₁, 25.₂), two male hooks 47 (47.₁, 47.₂) are configured at the turning corners between the two cover bodies 44 (44.₁, 44.₂) and two cover arms 45 (45.₁, 45.₂), and two female hooks 48 (48.₁, 48.₂) are configured at the distal end of the two cover arms 45 (45.₁, 45.₂), respectively. Correspondingly, two elastic arms 51 (51.₁, 51.₂) are respectively configured on the base side 16 at the bottom sections of the two windows 25 (25.₁, 25.₂). To accommodate the two male hooks 47 (47.₁, 47.₂) and two female hooks 48 (48.₁, 48.₂) on the two window covers 41 (41.₁, 41.₂), two female hooks 52 (52.₁, 52.₂) are configured at the distal ends of the two elastic arms 51 (51.₁, 51.₂) and two edge protrusions 53 (53.₁, 53.₂) are configured at the proximal ends of the two elastic arms 51 (51.₁, 51.₂), respectively. Slots 50 (50.₁, 50.₂) and 55 (55.₁, 55.₂) are configured on the base side 16 to form either of the two elastic arms 51 (51.₁, 51.₂). Similarly, two half-circle cut-downs 54 (54.₁ and 54.₂) are configured on the base side 16 adjacent to the proximate ends of the two elastic arms 51 (51.₁, 51.₂), respectively, to form the two edge protrusions 53 (53.₁, 53.₂).

FIG. 5A depicts the details for either one of the two structurally symmetrical window covers 41 (41.₁, 41.₂). As shown in FIG. 5A, the window cover 41.₁ includes the male hooks 47.₁, which is located between the cover body 44.₁ and the cover arm 45.₁; and the female hook 48.₁, which is located at the distal end of the cover arms 45.₁. FIG. 5B depicts the details for either one of the two structurally symmetrical elastic arms 51 (51.₁, 51.₂). As shown in FIG. 5B, the elastic arm 51.₁, which is formed between the two slots 50 (50.₁, 50.₂) on the base side 16, includes the female hook 52.₁. The half-circle cut-down 54.₁ is configured on the base side 16 adjacent to the proximate end of the elastic arm 51.₁, to form the edge protrusion 53.₁. FIG. 5C depicts assembling view, in which the female hook 48.₁ on the window cover 41.₁ is attached onto the edge protrusion 53.₁ when the window cover 41.₁ is installed onto the window 25.₁. Because the window cover 41.₂ and elastic arm 51.₂ are symmetrical to the window cover 41.₁ and elastic arm 51.₁, the structural details for installing the window cover 41.₂ onto the window 25.₂ are sufficiently reflected in the above descriptions to attach the window cover 41.₁ onto the window 25.₁.

It should be noted that even though FIGS. 4A-4B and 5A-5C illustrate the structures to mount the cover 18 onto the main body 11 in FIG. 1A. The main body 11′ or 11″ a shown in FIGS. 1B-1C may have the same structures as those in the main body 11 so that the cover 18 can also be mounted onto the main body 11′ or 11″ shown in FIG. 1B or 1C.

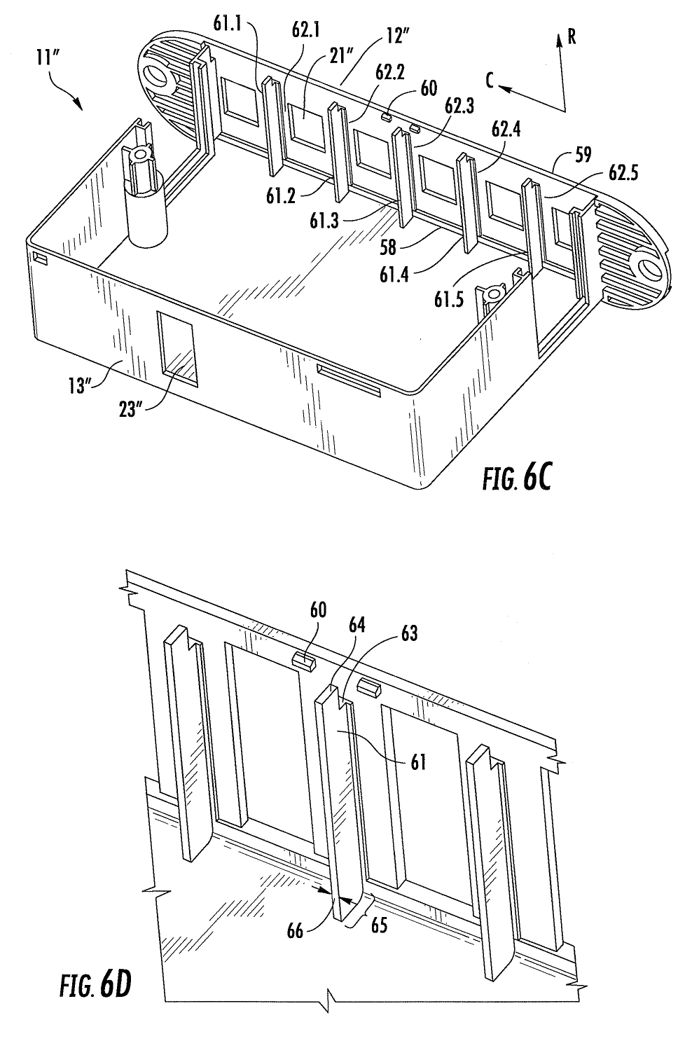

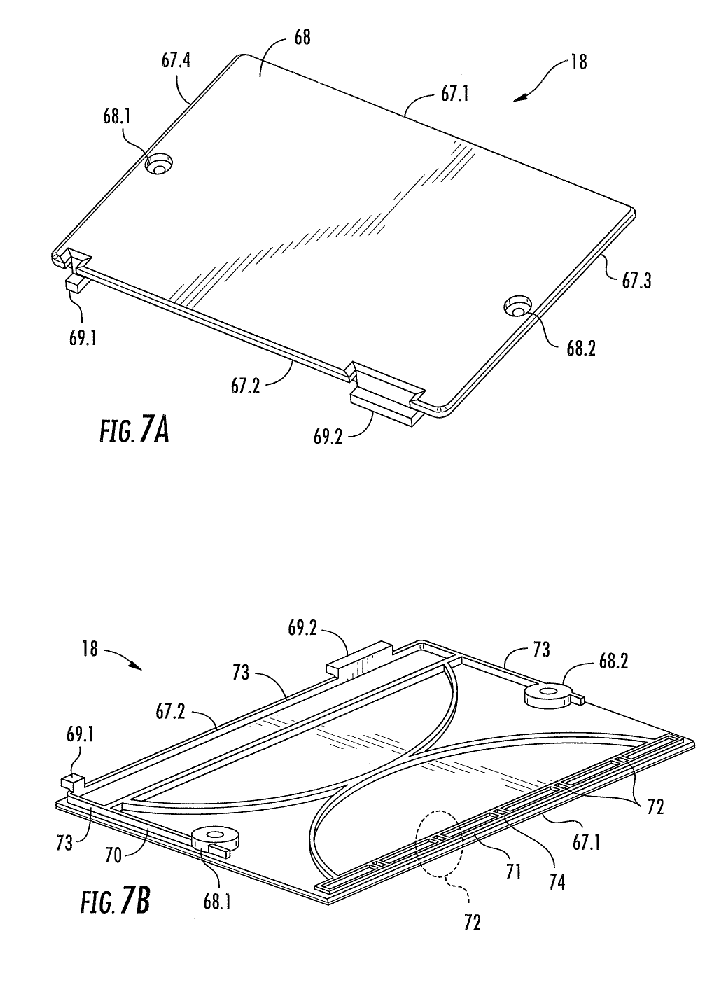

FIGS. 6A-6D depict the mechanism to enhance the strength of the front side 12 (12′ or 12″) on the main body 11 (11′ or 11″) in FIGS. 1A-1C. As shown in FIGS. 6A-6C, five sections of walls 62 (62.₁, 62.₂, 62.₃, 62.₄, 62.₅) are formed on the inner surface of the front side 12 (12′ or 12″) between two adjacent two rows of the apertures 21 (21′ or 21″). Five ribs 61 (61.₁, 61.₂, 61.₃, 61.₄, 61.₅) are configured on the inner surfaces of the five sections of walls 62 (62.₁, 62.₂, 62.₃, 62.₄, 62.₅), respectively. To attach the cover 18 onto the main body 11 (or 11′, 11″), two protrusions 60 are configured on the inner surface of the front side 12 (12′ or 12″) at two sides of the middle one of the five ribs 63 (63.₃).

The inventors realize that the front side 12 (12′ or 12″) may have a reduced strength because it includes a plurality of rows and/or columns of apertures 21 (21′ or 21″), especially when the fiber optic module housing is made from plastic material and the walls 62 between two rows of apertures 21 (21′ or 21″) are relatively narrow due to the size requirements to the apertures 21 (21′ or 21″) and the size limitation to the fiber optic module housing. In addition, the inventors realize, having a plurality of rows and/or columns of apertures 21 (21′ or 21″), the front side 12 (12′ or 12″) is more fragile along its row direction R than along its column direction C. This is so because the front side 12 (12′ or 12″) is joined, or integrally joined, with the base side 16 at its proximate edge 58 and with the top side 14 and bottom side 15 at its top section 26.₁ and bottom section 26.₂, respectively; while the front side 12 (12′ or 12″) is free of support at its distal edge 59, especially when the fiber optic module housing is open. Therefore, the embodiments in the present disclosure effectively compensate the strength for the front side 12 (12′ or 12″) by arranging the plurality of ribs 61 between the two adjacent rows of the apertures 21 along the row direction R.

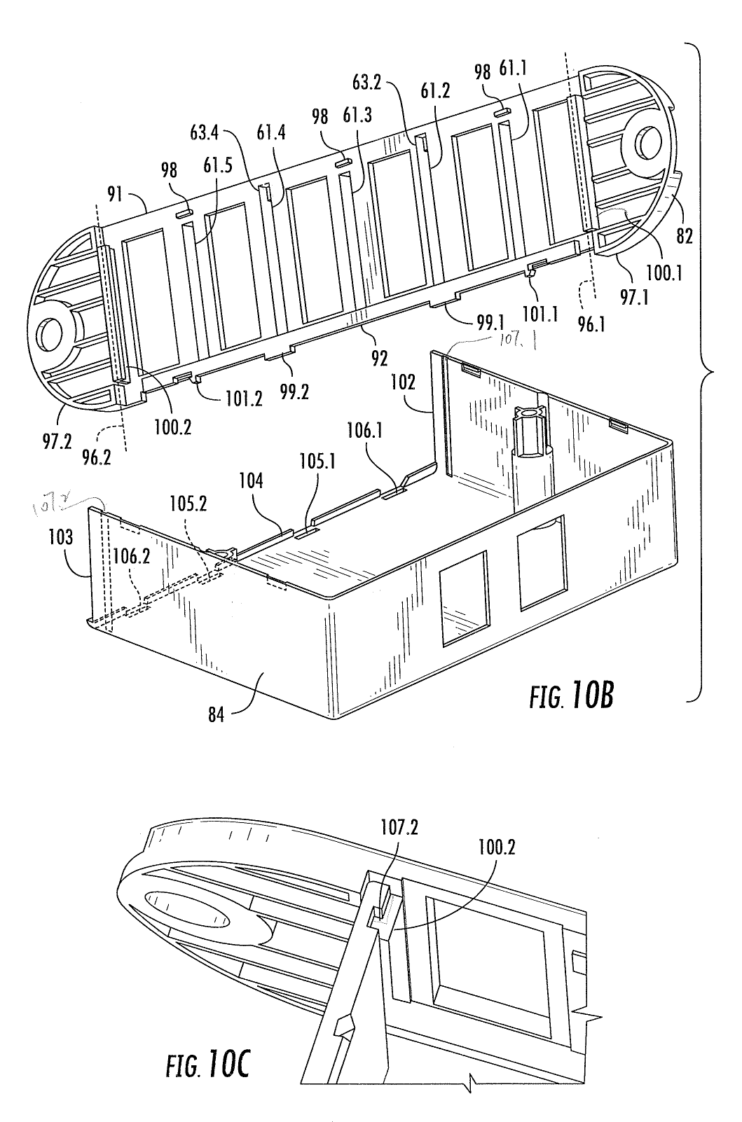

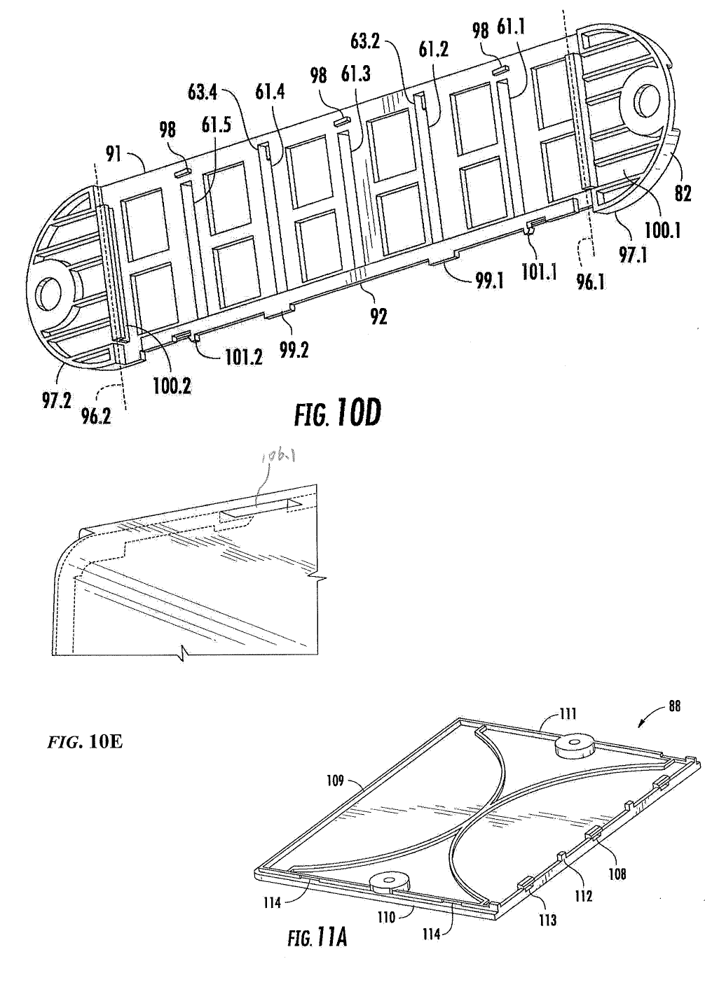

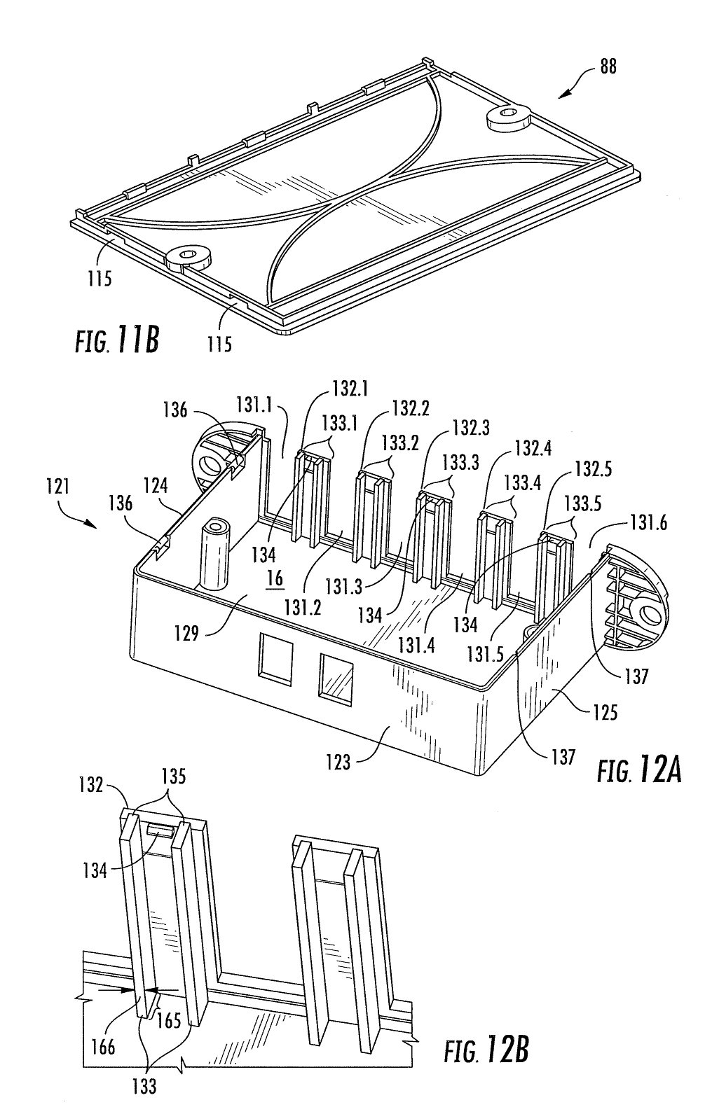

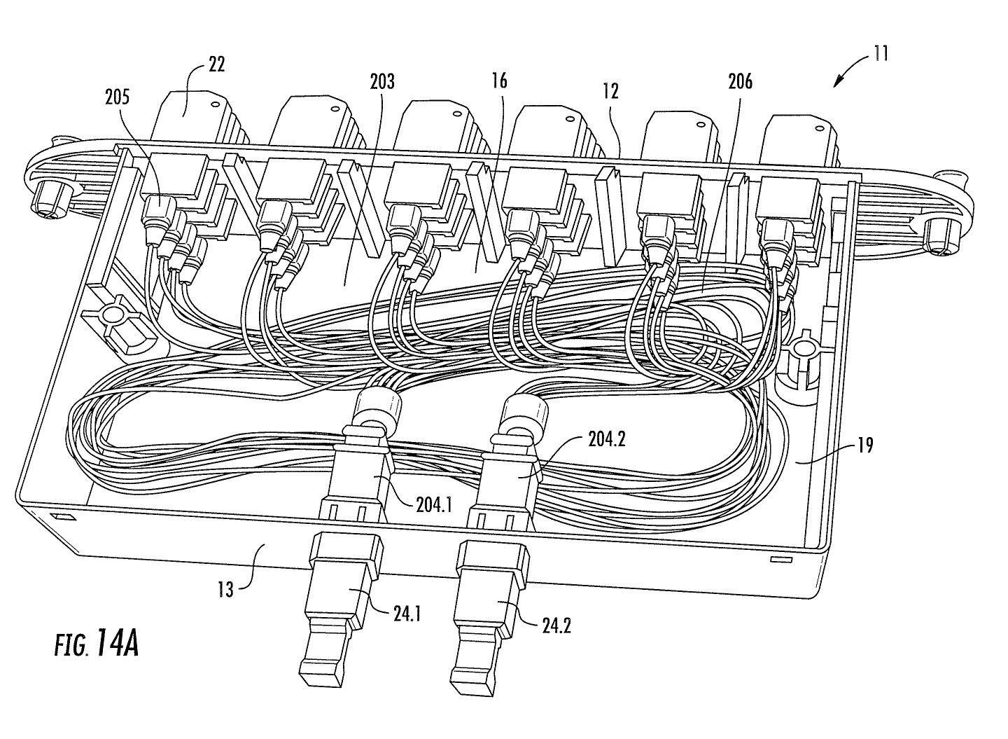

FIG. 6D depicts the structure of the ribs 61 of FIGS. 6A-6C in more details. As shown in FIG. 6D, a notch 63 is configured between each of the plurality of ribs and the back surface of the front side 12 (12′ or 12″) so as to form rib heads 64 on the plurality of ribs 61. With the structure shown in FIG. 6D, the inventors realize the limited size of the walls 62 may not allow having wider ribs 61. To further enhance the strength for the front side 12 (12′ or 12″), the ribs 61 can extend their lengths 65 in the direction transverse (or substantially transverse) to the walls 62 so that the length 65 on each of the plurality of ribs is greater than that of the widths 66 (i.e. extension parallel to the walls 62) on each of the plurality of ribs. To effectively compensate the strength for the front side, the ratio of (length 65/width 66) can be selected to be greater than 2.5 or greater than 3.3, for example. It should be appreciated such length extension for the ribs 61 will not negatively impact the accessibility to the components inside the fiber optic module housing because these ribs are embedded between two rows, or adjacent to one row, of the adapters. The ratio for the ribs 61 shown in FIG. 6D also applies to the ribs shown in FIGS. 10A-10D and FIGS. 12A-12B.

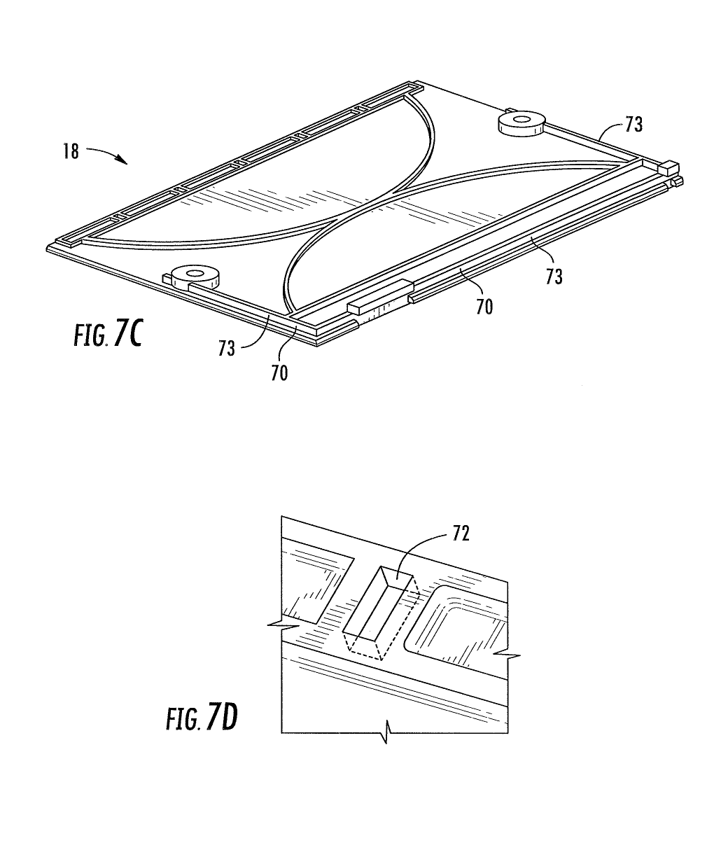

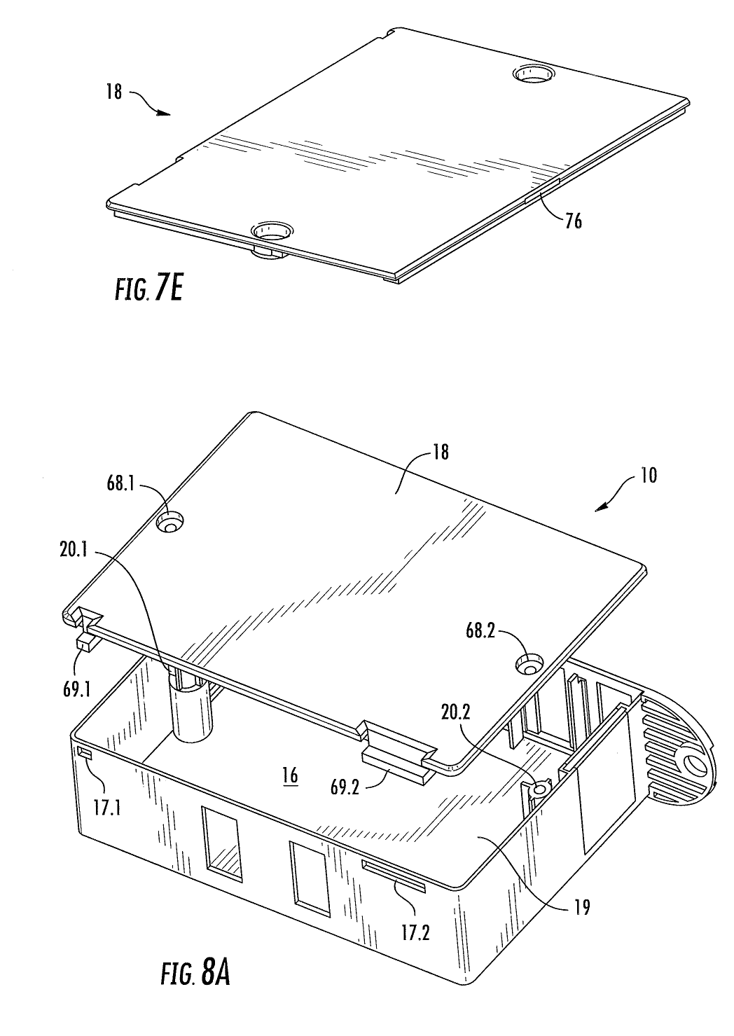

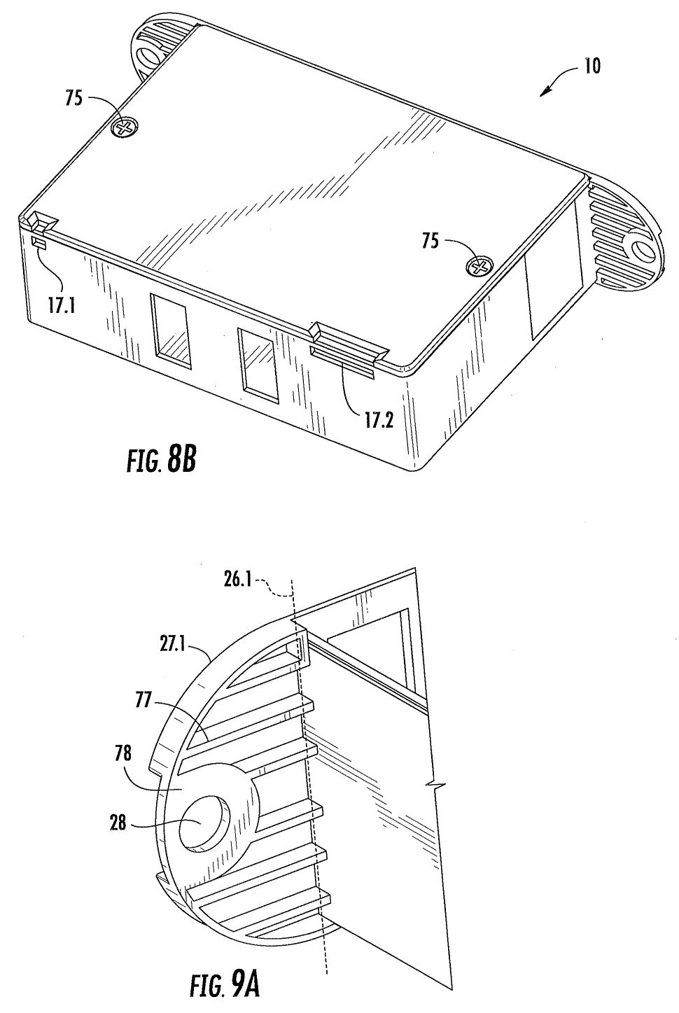

FIGS. 7A-7E depict the structures of the cover 18, that can be assembled onto the main body 11 (11′ or 11″) shown in FIGS. 1A-1C, in greater details. FIG. 7A shows the outer surface of the cover 18 having a front edge 67.₁, a rear edge 67.₂, a top edge 67.₃ and a bottom edge 67.₄. Two through holes 68.₁, 68.₂ are configured near to the top edge 67.₃ and a bottom edge 67.₄, respectively; and two snaps 69 (69.₁, 69.₂) are configured on the rear edge 67.₂. FIGS. 7B-7C depict the inner surface of the cover 18 in FIG. 7A. As shown in FIGS. 7B-7C, the cover 18 includes a protrusion strip 71 along the front edge 67.₁, on which a plurality of slots 72 (i.e., rib head receivers) 72 are configured. The cover 18 further includes a protrusion skirt 73 around the rear edge 67.₂, top edge 67.₃ and bottom edge 67.₄. FIG. 7D depicts an enlarged view of one of the rib head receiver 72 to show the details for all rib head receivers 72. FIG. 7E depicts the outer surface of the cover 18 in FIG. 7A, in which an opening 76 is configured on the middle portion on the front edge 67.₁ of the cover 18. In installing the cover 18 onto the main body 11 (11′ or 11″), each of the plurality of rib heads 64 is inserted into a corresponding one of the plurality of the rib head receivers 72, and the two protrusions 60 on the front side 12 (12′ or 12″) are inserted into the opening 76 on the front edge 67.₁ of the cover 18.

FIGS. 8A-8B illustrate a process of installing the cover 18 in FIGS. 7A-7D onto the main body 11 (11′ or 11″) in FIGS. 1A-1C. As shown in FIG. 8A, to install the cover 18 onto the main body 11 (11′ or 11″), a craft aligns the two through holes 68.₁, 68.₂ with the two bosses 20.₁, 20.₂; the two snaps 69.₁, 69.₂ with the two snap holes 17.₁, 17.₂; the plurality of rib heads 64 with the plurality of rib head receivers 72; and the protrusion strip 71 with the inner surface of the front side 12 (12′ or 12″); the two protrusions 60 with the opening 76, and the protrusion skirt 73 with the inner surfaces of the top side 14 and rear side 15, respectively. After inserting the two snaps 69.₁, 69.₂ into the two snap holes 17.₁, 17.₂, the craft presses the cover 18 down onto the main body 11 (11′ or 11″) so that the plurality of rib heads 64 are inserted into the plurality of rib head receivers 72 and the two protrusions 60 are inserted into the opening 76. The side surface of the protrusion strip 71 is so configured to touch or loosely touch the inner surface of the front side 12. Similarly, the side surface 70 of the protrusion skirt 73 is so configured to touch or loosely touch the inner surfaces of the top side 14 and bottom side 15. In such a design, the cover 18 is stably attached to the main body 11 (11′ or 11″) after it is pressed down onto the same so that the craft can further secure the cover 18 on the main body 11 (11′ or 11″). As shown in FIG. 8B, to assemble the fiber optic module housing (or module), the craft drives the two self-taped screws 75 into the two bosses 20 to secure the cover 18 on the main body 11 (11′ or 11″).

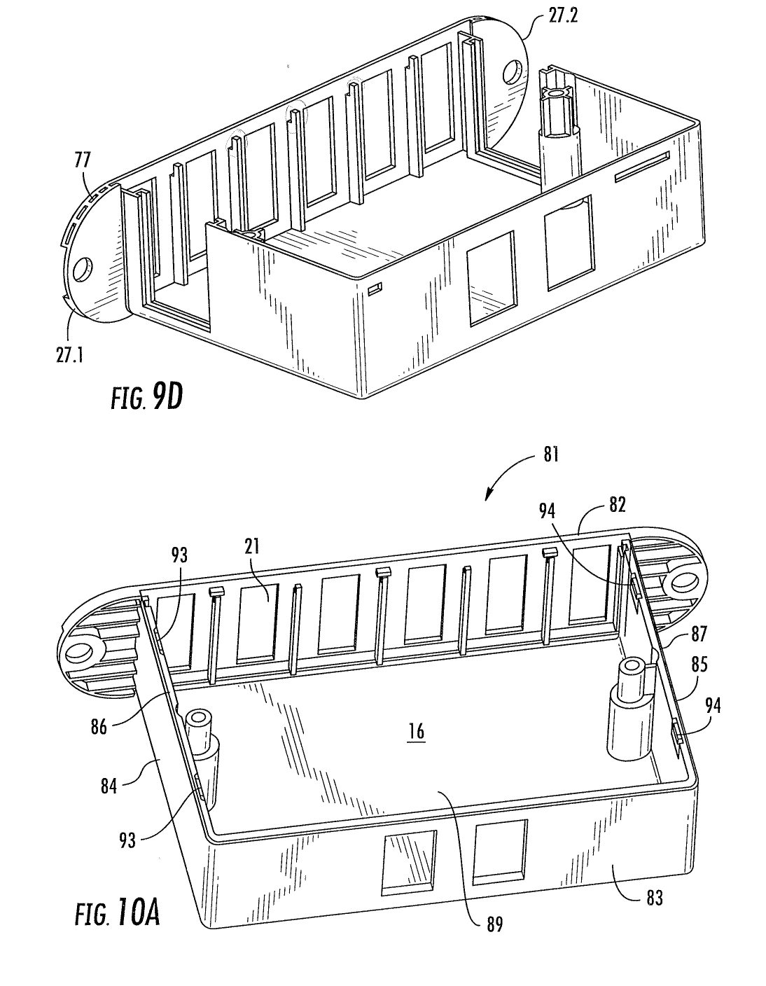

FIGS. 9A-9D depict the structures of the two flanges 27 (27.₁, 27.₂) shown in FIGS. 1A-1C in greater details. FIG. 9A shows one structure arrangement of the two flanges 27 (27.₁, 27.₂). As shown in FIG. 9A, a plurality of ribs 77 are configured on the outer surface of the two flanges 27 along the elongated direction of the front side 12 (12′ or 12″). A flat area 78, which has the same height as that of the ribs 77, is configured around the plug hole 28. It should be appreciated these two flanges would be more fragile in the width direction than in the elongated direction of the front side 12 (12′ or 12″) because the two flanges 27 extend out from the top section 26.₁ and bottom section 26.₂ along the elongated direction of the front side 12 (12′ or 12″). Therefore, arranging the ribs 77 along the elongated direction of the front side 12 (12′ or 12″) effectively enhances the strength of the two flanges 27. It should also be appreciated the flat area 78 around the plug hole 28 is used to fitly engage the supporting surface within the rack slot (not shown) so that the ribs 77 on the two flanges 27 do not negatively affect the engagement between the flanges and the supporting surface in the rack slot. As shown in FIG. 9B, the ribs 61 on the front side 12 (12′ or 12″) are arranged along the row direction R while the ribs 77 on the two flanges are arranged along elongated direction C of the front side 12 (12′ or 12″). These two directions are perpendicular with each other.

FIG. 9C shows another structure arrangement of the two flanges 27 (27.₁, 27.₂), in which a plurality of ribs 77 are configured on the front surface of the two flanges 27 along the elongated direction of the front side 12 (12′ or 12″). FIG. 9D shows still another structure arrangement of the two flanges 27 (27.₁, 27.₂). As shown in FIG. 9D, each of the two flanges 27 includes two layers and a plurality of ribs 77 are configured between the two layers along the elongated direction of the front side 12 (12′ or 12″).

To assemble a fiber optic module using the main body 11 (11′ or 11″) in the first embodiment, a craft may perform the following steps:

To begin with, a craft may install a first set of fiber optic adapters (six quadruplet or 12 duplex LC fiber optic adapters 22 as shown in FIG. 14A, twelve duplex LC fiber optic adapters 22′ as shown in FIG. 14B, or six duplex LC fiber optic adapters 22″ as shown in FIG. 14C, for example) into a first set of apertures (one column of six apertures 21 and 21″ as shown in FIGS. 1A and 1C, or two columns of twelve apertures 21′ as shown in FIG. 1B, for example) on the front side 12, 12′ or 12″ and install a first set of connectors (twenty-four LC fiber optic connectors 205 and 205′ as shown in FIGS. 14A-14B, or twelve LC fiber optic connectors 205″ as shown in FIG. 14C, for example) into the first set of adapters. Each of the first set of connectors is linked to a corresponding one connector in the second set of connectors 204 (204′ or 204″) through fiber optic cables 206 (206′ or 206″) to form a wiring harness 203 (203′ or 203″). Because the front side 12 (12′ or 12″) has two windows 25 (25.₁, 25.₂) on the top side 14 and bottom side 15, respectively; the craft may adjust the first set of adapters 22 (22′ or 22″) and first set of connectors 205 (205′ or 205″), especially for the two adapters at the top most row and bottom most row, through the two windows 25.

Then the craft may install a second set of adapter(s) (two MTP adapters 24 (or 24′) as shown in FIGS. 14A and 14B, or one MTP adapter 24″ as shown in FIG. 14C, for example) into a second set of aperture(s) (two apertures 23 (or 23′) as shown in FIGS. 1A and 1B, one aperture 23″ as shown in FIG. 1C, for example) on the rear side 13 (13′ or 13″) and install the second set of connectors 204 (204′ or 204″) into the second set of adapter(s) 24 (24′ or 24″).

Finally, the craft installs and secures the cover 18 onto the main body 11 (11′ or 11″) to form a fiber optic module.

FIGS. 10A-10C depict the rear perspective view of an exemplary fiber optic module housing 80, which includes a main body 81 and a cover 88, according to the second embodiment of the present disclosure.

FIG. 10A depicts the rear perspective view of the exemplary main body 81 of the fiber optic module housing 80. As shown in FIG. 10A, the main body 81 has a similar structure as that of the main body 11 shown in FIG. 1A, but the front side 82 of the main body 81 is separately made and the top side 84 and bottom side 85 do not have windows thereon. Specifically, the main body 81 includes a front side 82, a rear side 83, a top side 84, a bottom side 85, a base side 16. The rear side 83, top side 84, bottom side 85 and a base side 16 are made as one base unit to form a body base while the front side 82 is separately made and is later installed onto the body base to form the main body 81 which has a chamber 89.

FIG. 10B depicts the rear perspective view of the exemplary main body 81 of the fiber optic module housing 80, in which the front side 82 is separated from the main body 81. As shown in FIG. 10B, the front side 82 includes a first edge 91 and a second edge 92. The front side 82 further includes a top section 96₁ and a bottom section 96.₂ at the locations that are aligned with the top side 84 and the bottom side 85 on the front side 82, respectively. To secure the fiber optic module housing 80 in a rack slot on a rack cabinet, two flanges 97 (97₁, 97.₂) are configured extending from the top section 96.₁ and bottom section 96.₂ of the front side 82. The structural arrangement of the two flanges 97 is similar to that of the two flanges 27 shown in FIGS. 9A-9D for the first embodiment.

Like the front side 12 shown in FIG. 1A, the front side 82 includes six rows and one column of apertures 21 as shown in 10B. Five ribs 61 (61.₁, 61.₂, 61.₃, 61.₄, 61.₅) are configured on the inner surface of the front side 82 between two adjacent rows of the apertures 21 along the row direction. To secure the cover 88, three protrusions 98 are configured along the first edge 91 of the front side 82 above the three ribs 61.₁, 61.₃, 61.₅, respectively; two notches 63 (63.₂, 63.₄) are configured along the first edge 91 of the front side 82 above two ribs 61.₂, 61.₄, respectively; and two sets of protrusions 93 and 94 are configured on the open edges 86 and 87 of the top side 84 and bottom side 85, respectively. To attach the front side 82 onto the base side 16, two protrusions 99.₁, 99.₂ are configured on the second edge 92 in the middle section of the front side 82 and two snaps 101.₁, 101.₂ are configured on the second edge 92 near to the top and bottom sections 96.₁ and 96.₂, respectively.

As shown in FIG. 10B, the top side 84, bottom side 85 or base side 16 has its respective open edge 102, 103 or 104. To match the second edge 92 of the front side 82, two slots 105.₁, 105.₂ are configured in the middle section on the open edge 104 of the base side 16, and two snap holes 106.₁, 106.₂ are configured on the open edge 104 of the base side 16 near to the top side 84 and bottom side 85, respectively. To attach the front side 82 onto the open edge 104 on the base side 16, the two protrusions 99.₁, 99.₂ on the front side 82 are aligned with the two slots 105.₁, 105.₂ on the base side 16, respectively; and the two snaps 101.₁, 101.₂ on the front side 82 are aligned with the two snap holes 106.₁, 106.₂ on the base side 16, respectively.

To attach the front side 82 onto the open edge 102 of the top side 84 and the open edge 103 on the bottom side 85, two symmetrical hooks 100 (100.₁, 100.₂) are configured on the inner surface near to the top section 96.₁ and 96.₂ on the front side 82, respectively. To match the two hooks 100 (100.₁, 100.₂) on the front side 82, two slots 107 (107.₁, 107.₂) are symmetrically configured on the inner surfaces near to the open edge 102 on the top side 84 and the open edge 103 on the bottom side 85, respectively.

FIG. 10C shows the structure details in which one of the two hooks 100 (100.₂) on front side 82 near to top section 96.₂ is engaged with one of the two slots 107 (107.₁, 107.₂) on top side 84. Because the structures for the two hooks 100 (100.₁, 100.₂) and the two slots 107 (107.₁, 107.₂) are symmetrically configured, the engagement structures between the other one of the two hooks 100 (100.₁) and the other one of the two slots 107 (107.₁) are sufficiently reflected in the description in connection with those between the hook 100.₂ and slot 107.₂.

FIG. 10D shows a front side 82′, which is identical to that shown in FIG. 10B except that the front side 82″ has two rows of apertures thereon.

FIG. 10E shows the structures of the snap 106.₁ configured on the open edge of the base side 16 in greater detail. Because the snap hole 106.₂ is structurally symmetrical to the snap hole 106.₁, the structure details for the snap hole 106.₂ are sufficiently reflected in FIG. 10E.

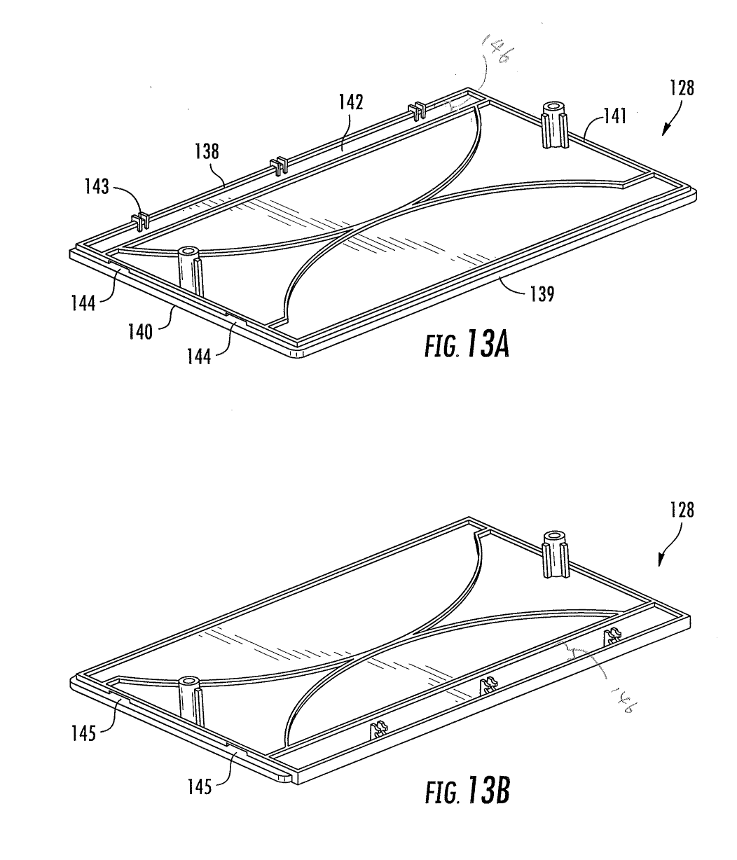

FIGS. 11A-11B depict the structures of the cover 88, which is mentioned in connection with the description in FIG. 10A, in greater detail. As shown in FIG. 11A, the cover 88 includes a front edge 108, a rear edge 109, a top edge 110 and a bottom edge 111. To secure the cover 88 onto the main body 81, the cover 88 includes two protrusions 112 and three snaps 113 on the front edge 108 and two sets of slots 114 and 115 on the top edge 110 and the bottom edge 111, respectively.

To install the cover 88 onto the main body 81, a craft needs to align the two protrusions 112 and three snaps 113 on the cover 88 with the two notches 63 (63.₂, 63.₄) and three protrusions 98 on the front side 82, respectively. The craft also needs to align the two sets of protrusions 93 and 94 on the top side 84 and the bottom side 85 with the two sets of slots 114 and 115 on the cover 88, respectively. After the alignments, the craft pushes the cover 88 onto the main body 81. Consequently, the two protrusions 112 on the cover 88 are inserted into the two notches 63 on the front side 82; the three snaps 113 on the cover 88 engage the three protrusions 98 on the front side; and the two sets of protrusions 93 and 94 on the top side 84 and the bottom side 85 are inserted into the two sets of slots 114 and 115 on the cover 88; respectively.

To assemble a fiber optic module using the main body 81 in the second embodiment, a craft may perform the steps as follows:

To begin with, a craft may install a first set of fiber optic adapters (six quadruplet LC fiber optic adapters for example) into a first set of apertures (six apertures 21 as shown in FIG. 11A for example) on the front side 82 and plug a first set of connectors (twenty four LC fiber optic connectors for example) into the first set of adapters. Each of the first set of connectors is linked to a respective one in a second set of connectors through fiber optic cables to form a wiring harness. Because the front side 82 is separated from the main body 81, the craft can perform the installation of the first set of adapters and the first set of connectors in a spacious location.

Afterwards, the craft may install a second set of adapter(s) (one or two MTP adapters as for example) into a second set of aperture(s) on the rear side 83 and plug the second set of connectors into the second set of adapter(s).

After properly installing the first and second sets of adapters, together with first and second sets of connectors, the crafter may install the front side 82 onto the main body 81.

Finally, the craft installs and secures the cover 88 onto the main body 81.

FIG. 12A shows the rear perspective view of an exemplary main body 121 according to the third embodiment of the present disclosure. As shown in FIG. 12A, the main body 121 has a similar structure as that of the main body 11 shown in FIG. 1A, except that the front side in the third embodiment includes a plurality of rows of slots for supporting a first set of fiber optic adapters. Specifically, the main body 121 includes a front side 122, a rear side 123, a top side 124, a bottom side 125, a base side 16. The front side 122, rear side 123, top side 124, bottom side 125 and a base side 16 are made as one unit to form the main body 121 having a chamber 129.

As shown in FIG. 12A, the front side 122 includes six rows of open slots 131 (131.₁, 131.₂, 131.₃, 131.₄, 131.₅) for supporting a first set of adapters. Five wall sections 132 (132.₁, 132.₂, 132.₃, 132.₄, 132.₅) are formed between two adjacent rows of open slots. Five pairs of ribs 133 (133.₁, 133.₂, 133.₃, 133.₄, 133.₅) are configured on the inner surface on the five wall sections 132, respectively. Three protrusions 134 are configured on three of the five wall sections 132 (132.₁, 132.₃, 132.₅). Like the main body 81 shown in FIG. 10A, two sets of protrusions 136 and 137 are configured on the open edges of the top side 124 and bottom side 125, respectively, to attach the cover 128.

FIG. 12B shows the structures of the five wall sections 132 (132.₁, 132.₂, 132.₃, 132.₄, 132.₅), five pairs of ribs 133 (133.₁, 133.₂, 133.₃, 133.₄, 133.₅) and three protrusions 134. As shown in FIG. 12B, each of the five pairs of ribs 133 is higher than that of a respective one of the five wall sections 132 to form a pair of rib heads 135 on each of the five pairs of the ribs 133. All five pairs of 133 (133.₁, 133.₂, 133.₃, 133.₄, 133.₅) have a length 65 and a width 66 with the length 165 being greater than the width 166.

FIGS. 13A-13B depict the structures of the cover 128, which is mentioned in connection with the description for FIG. 12A, in greater detail. As shown in FIG. 13A-13B, the cover 128 includes a front edge 138, a rear edge 139, a top edge 140 and a bottom edge 141. To secure the cover 128 onto the main body 121, the cover 128 includes a slot 142 near to and along the front edge 138, with a width 146 that matches the length 165 of the five pairs of the ribs 133, so that the slot 142 is suitable for receiving and retaining the five pair of ribs 133. The cover 128 further includes three snaps 143 on the front edge 138 and two sets of slots 144 and 145 on the top edge 140 and the bottom edge 141, respectively.

To install the cover 128 onto the main body 121, a craft needs to align the rib heads 135 and protrusions 134 on the front side 122 with the slot 142 and the snaps 143 on the cover 128. The craft also needs to align the two sets of protrusions 136 and 137 on the top side 124 and the bottom side 125 with the two sets of slots 144 and 145 on the cover 128. After the alignment, the craft pushes the cover 128 down onto the main body 121. As a result, the slot 142 on the cover 128 receives the rib heads 135 on the font side 122, the snaps 143 on the cover 128 engage the protrusions 134 on the front side 122 and the two sets of protrusions 136 and 137 insert into the two sets of the slots 144 and 145 on the cover 128, respectively.

To assemble a fiber optic module using the main body 121 in the second embodiment, a craft may perform the steps as follows:

To begin with, a craft may install a first set of fiber optic adapters (six quadruplet or 12 duplex LC fiber optic adapters for example) into a first set of slots (six slots for example) on the front side 122 and install a first set of connectors (twenty-four LC fiber optic connectors for example) into the first set of adapters. Each of the first set of connectors is linked to a respective one in a second set of connectors through fiber optic cables to form a wiring harness. Because each of the first set of slots has a top opening, the craft can properly install four LC fiber optic connectors onto each of the six LC fiber optic adapters before installing the LC fiber optic adapter into a corresponding slot.

After properly installing the first set of adapters onto the slots on the front side 122, the craft may install a second set of adapter(s) (one or two MTP adapters for example) into a second set of aperture(s) on the rear side 83 and install the second set of connectors into the second set of adapter(s).

Finally, the craft installs and secures the cover 128 onto the main body 121.

It should be noted that the fiber optic module housings shown in FIGS. 10-13 also have two flanges on their front sides. The two flanges in FIGS. 10-13 are not descried in details here because the two flanges in FIGS. 10-13 are identical to or similar with those shown in FIGS. 1-9.

FIGS. 14A-14C depict fiber optic module according to the embodiments in the present disclosure.

FIG. 14A shows a fiber optic module formed by using the main body 11 in FIG. 1A, in which all connection components (including adapters, connectors and harness) are installed therein. As shown in FIG. 14A, six quadruplet or 12 duplex LC fiber optic adapters 22 are installed onto the six rows and one column of apertures 21 on the front side 12 and two MTP fiber optic adapters 24 (24.₁, 24.₂) are installed onto the two apertures 23 on the rear side 13. Each of the two fiber optic MTP adapters 24 receives an inputting optic fiber ribbon cable that is split into twelve connections within the MTP adapter 24. A harness 203 is installed in the chamber 19, which includes two MTP fiber optic connectors 204 (204.₁, 204.₂), twenty-four LC fiber optic connectors 205 and two sets of twenty-four fiber optic cables 206 (206.₁, 206.₂). Each of the two sets includes twelve of the twenty-four fiber optic cables 206 (206.₁, 206.₂). One ends of the twelve fiber optic cables (not shown) in a cable set are connected to one of the two MTP fiber optic adapters 24 (24.₁ or 24.₂) and the other ends of the twelve fiber optic cables (not shown) in the cable set are connected to the corresponding twelve LC fiber optic connectors 205. More specifically, each of the twelve LC fiber optic connectors 205 is connected to an MTP adapter 24 (24.₁ or 24.₂) through one corresponding connection cable so as to link the two MTP fiber optic adapters 24 (24.₁, 24.₂) and the twenty-four LC fiber optic connectors 205 as one unit.

As shown in FIG. 14A, the two MTP fiber optic connectors 204 (204.₁, 204.₂) are plugged onto the two MTP fiber optic adapters 24 (24.₁, 24.₂), respectively; while the twenty-four LC fiber optic connectors 205 are plugged onto the six quadruplet or 12 duplex LC fiber optic adapters 22 with each of the six quadruplet LC fiber optic adapters receiving four LC fiber optic connectors. In this manner, when inputting fiber optic cables (not shown) external to the fiber optic module are plugged into the two MTP fiber optic connectors 204, optical connections are established between the inputting fiber optic cables and the six quadruplet or 12 duplex LC fiber optic adapters 22.

FIG. 14B shows a fiber optic module formed by using the main body 11′ in FIG. 1B, in which all connection components (including adapters, connectors and harness) are installed therein. As shown in FIG. 14B, twelve duplex LC fiber optic adapters 22′ are installed onto the six rows and two columns of apertures 21′ on the front side 12′ and two MTP fiber optic adapters 24′ (24′.₁, 24′.₂) are installed onto the two apertures 23′ on the rear side 13′. Each of the two fiber optic MTP adapters 24′ receives an inputting optic fiber cable with 12 fiber cores through an MTP connector. Two harness 203′ are installed in the chamber 89, which includes a MTP fiber optic connector 204′ (204′.₁, 204′.₂), twelve LC fiber optic connectors 205′ and two sets of fiber optic cables 206′ (206′.₁, 206′.₂) with each set including twelve fiber optic cores. One ends of the twelve fiber optic cables (not shown) in a cable set are connected to one of the two MTP fiber optic adapters 24′ (24′.₁ or 24′.₂) and the other ends of the twelve fiber optic cables (not shown) in the cable set are connected to a corresponding one of the twelve LC fiber optic connectors 205′. More specifically, each of the twelve LC fiber optic connectors 205′ is connected to an MTP adapter 24′ (24′.₁ or 24′.₂) through a corresponding connection cable so as to link the two MTP fiber optic adapters 24′ (24′₄, 24′.₂) and the twenty-four LC fiber optic connectors 205′ as one unit.

As shown in FIG. 14B, the two MTP fiber optic connectors 204′ (204′.₁, 204′.₂) are plugged onto the two MTP fiber optic adapters 24′ (24′.₁, 24′.₂), respectively; while the twenty-four LC fiber optic connectors 205′ are plugged onto the twelve duplex LC fiber optic adapters 22′ with each of the twelve duplex LC fiber optic adapters receiving two LC fiber optic connectors. In this manner, when inputting fiber optic cables (not shown) external to the fiber optic module are plugged into the two MTP fiber optic connectors 204′, optical connections are established between the inputting fiber optic cables and the twelve duplex LC fiber optic adapters 22.

FIG. 14C shows a fiber optic module formed by using the main body 11″ in FIG. 1C, in which all connection components (including adapters, connectors and harness) are installed therein. As shown in FIG. 14C, six duplex LC fiber optic adapters 22″ are installed onto the six rows and one column of apertures 21″ on the front side 12″ and one MTP fiber optic adapter 24″ is installed onto the aperture 23″ on the rear side 13″. The fiber optic MTP adapter 24″ receives an inputting optic fiber that is split into twelve connections within the MTP adapter 24″. A harness 203″ is installed in the chamber 129′, which includes an MTP fiber optic connector 204″, twelve LC fiber optic connectors 205″ and a set of twelve fiber optic cables 206. One ends of the twelve fiber optic cables (not shown) are connected to the MTP fiber optic adapter 24″ and the other ends of the twelve fiber optic cables (not shown) are connected to the twelve LC fiber optic connectors 205, respectively so as to link the MTP fiber optic adapter 24 and the twelve LC fiber optic connectors 205 as one unit.

As shown in FIG. 14C, the MTP fiber optic connector 204″ is plugged onto the fiber optic adapter 24″, while the twelve LC fiber optic connectors 205″ are plugged onto the six duplex LC fiber optic adapters 22″ with each of the six duplex LC fiber optic adapters receiving two LC fiber optic connectors. In this manner, when inputting fiber optic cables (not shown) external to the fiber optic module are plugged into the MTP fiber optic connector 204″, optical connections are established between the inputting fiber optic cables and the six duplex LC fiber optic adapters 22″, respectively.

A craft can form a fiber optic module by installing the cover 18, 88, or 128 onto the main bodies 11, 11′ or 11″ as shown in FIGS. 14A-14C.

It should be appreciated that, to reduce manufacturing cost, all components of the main bodies of fiber optic module housings shown in the figures in connection with the present disclosure can be made by injection molding or extrusion process as one unit (or one piece) using plastic materials. In that connection, the overall structures of the present disclosure are designed suitable for the injection molding or extrusion process and to enhance the strength of the fiber optic module housings made from plastic materials.

It should also be appreciated that the mechanisms to attach module housing cover (or the front side) onto the module housing main body are evenly distrusted along the open edges of the module housing cover and the module housing main body to avoid using long and thing structures to cause “concentrated force impact spots or sections”, which is beneficial when the module housing is made from plastic materials. In the resent disclosure, the open edges refer to the edges on the housing main body, cover and the front side that are free from support before assembly.

It should be noted that the present disclosure contains several novel and inventive embodiments. Thus, the descriptions and figures in this application are illustrative to explain the principle for a person skilled in the art to practice the three embodiments. Therefore, any one of theses embodiments should be deemed generic to and/or independent from each other.

It will be apparent to those skilled in the art that various modifications and variations can be made to the embodiments described herein without departing from the spirit and scope of the claimed subject matter. Thus, it is intended that the specification cover the modifications and variations of the various embodiments described herein, provided such modification and variations come within the scope of the appended claims and their equivalents.

What is claimed is:

1. A fiber optic module housing, comprising:
a front side having a plurality of rows of apertures for supporting a first set of fiber optic adapters;
a rear side having a plurality of apertures for supporting a second set of fiber optic adapters;
a top side having a window that is located near to the joint location between the front side and the top side;
a bottom side having a window that is located near to the joint location between the front side and the bottom side; and
a base side;
wherein the front side, rear side, top side, bottom side and base side form a main body having an internal chamber.

2. The fiber optic module housing of claim 1, further comprising:
a plurality of ribs with each of the plurality of ribs being configured between two adjacent rows of the apertures on the inner surface of the front side.

3. The fiber optic module housing of claim 1, further comprising:
two window covers for sealing the two windows that are located on the top side and bottom side, respectively.

4. The fiber optic module housing of claim 3, wherein:
the two windows are configured adjacent to the adapters that are located at the top-most row and the bottom-most row.

5. The fiber optic module housing of claim 1, further comprising:
a cover that is amounted on the main body of the fiber optic module housing.

6. The fiber optic module housing of claim 1, wherein:
the front side, the rear side, top side, bottom side and base side are made as one piece using plastic materials.

7. The fiber optic module housing of claim 1, further comprising:
a cover that is amounted on the main body of the fiber optic module housing.

8. The fiber optic module housing of claim 7, further comprising:
a plurality of attachment means for securing the cover onto the main body, wherein the plurality of attachment means are disposed on and round the open edges of the cover, front side and the body base.

9. The fiber optic module housing of claim 8, wherein:
the front side is made from plastic material.

10. A method for assembling a fiber optic module, comprising the steps of:
providing a cover and two window covers;
providing a main body that comprises:
a front side having a plurality rows of apertures for supporting a first set of fiber optic adapters;
a rear side having a plurality of apertures for supporting a second set of fiber optic adapters;
a top side having a window that is located near to the joint location between the front side and the top side;
a bottom side having a window that is located near to the joint location between the front side and the bottom side; and
a base side;
wherein the front side, rear side, top side, bottom side and base side form a main body having an internal chamber;
installing the first set of fiber optic adapters on the plurality of rows of apertures on the front side and the second set of fiber optic adapters on the rear side;
installing a first set of fiber optic connectors onto the first set of fiber optic adapters and a second set of fiber optic connectors onto the second set of fiber optic adapters, wherein a plurality of fiber optic cables are connected between the first set of fiber optic connectors and the second set of fiber optic connectors to form a wiring harness;
installing the two window covers on the two windows on the top side and the bottom side, respectively; and
installing the cover on the main body to form the fiber optic module.

11. The method of claim 10, wherein the main body further comprises:
a plurality of ribs with each of the plurality of ribs being configured between two adjacent rows of the apertures.

12. The method of claim 10, wherein:
the front side, the rear side, top side, bottom side and base side are made as one piece using plastic materials.

13. A fiber optic module housing, comprising:
a front side having a plurality of rows of apertures for supporting a first set of fiber optic adapters;
a rear side having a plurality of apertures for supporting a second set of fiber optic adapters; and
a top side, a bottom side and a base side;
wherein the front side includes a plurality of ribs with each of the ribs being configured between two adjacent rows of the apertures at the inner surface of the front side.

14. The fiber optic module housing of claim 13, wherein:
the front side is separately made and installed onto the main body;
wherein the front side, rear side, top side, bottom side and base side form a main body having an internal chamber.

15. The fiber optic module housing of claim 13, wherein:
each of the plurality of ribs has a length and a width with the length being grater than the width;
the rib length extends vertically out from the inner surface of the front side.

16. The fiber optic module housing of claim 13, wherein the front side has a top section and a bottom section, the fiber optic module housing further comprising:
two flanges that are extended out from the top and bottom sections of the front side, respectively; and
a plurality of ribs that are configured on the front surface or back surface on each of the two flanges.

17. The fiber optic module housing of claim 16, wherein:
the front side comprises an attachment mechanism near the top section and bottom section of the front side and an attachment mechanism on the proximate edge of the front side;
the open edges of the top side and bottom side comprises an attachment mechanism that matches with the attachment mechanism on the front side;
the open edge of the base side comprises an attachment mechanism that matches with the attachment mechanism on the proximate edge of the front side.

18. The fiber optic module housing of claim 13, further comprising:
a cover that is amounted on the main body of the fiber optic module housing.

19. The fiber optic module housing of claim 13, wherein:
the front side, the rear side, top side, bottom side and base side are made as one piece using plastic materials.

20. A method for assembling a fiber optic module, comprising the steps of:
providing a cover;
providing a front side having plurality of apertures for supporting a second set of fiber optic adapters, wherein the front side includes a plurality of ribs with each of the ribs is configured between two adjacent rows of the apertures at the inner surface of the front side;
providing a body base that includes:
a rear side having a plurality of apertures for supporting a second set of fiber optic adapters; and
a top side, a bottom side and a base side;
installing the front side onto the body base to form a main body having an internal chamber;
installing the first set of fiber optic adapters onto the plurality of rows of apertures on the front side and the second set of fiber optic adapters on the rear side;
installing a first set of fiber optic connectors onto the first set of first fiber optic adapters and a second set of fiber optic connectors onto the second set of fiber optics, wherein a plurality of fiber optic cables are connected between the first set of fiber optic connectors and the second set of fiber optic connectors to form a wiring harness; and
installing the cover onto the main body to form the fiber optic module.

21. The method of claim 20, wherein the front side comprises:
a plurality of ribs with each of the plurality of ribs being configured between two adjacent rows of the plurality of apertures.

22. The method of claim 20, wherein:
the front side is made from plastic materials; and
the rear side, top side, bottom side and base side are made as one-piece unit using plastic materials.
